(19) United States
(12) Patent Application Publication
(10) Pub. No.: US 2023/0003280 A1
(43) Pub. Date: Jan. 5, 2023

(54) SEAMLESS ADHESIVE JOINTS AND MECHANICAL BELTS INCLUDING SEAMLESS ADHESIVE JOINTS

(71) Applicant: SAINT-GOBAIN PERFORMANCE PLASTICS CORPORATION, Solon, OH (US)

(72) Inventors: Dahlia AMATO, Malvern, PA (US); Douglas Amato, Troy, NY (US); Ganesh Perugu, Corby (GB)

(21) Appl. No.: 17/807,171

(22) Filed: Jun. 16, 2022

Related U.S. Application Data
(60) Provisional application No. 63/214,996, filed on Jun. 25, 2021.

(51) Int. Cl. F16G 3/10

(52) U.S. Cl. CPC F16G 3/10

(57) ABSTRACT

The present disclosure relates to an unassembled multilayer mechanical belt may include a first angled step-joint tab, a second angled step-joint tab, and a central overlap region between the first angled step-joint tab and the second angled step-joint tab. The central overlap region may include a first mechanical belt material layer overlying and adhered to a second mechanical belt material. The first angled step-joint tab may include a first tab backing material and a first tab adhesive material. The second angled step-joint tab may include a second tab backing material and a second tab adhesive material. The first angled step-joint tab may be configured to overlap with and adhere to the second angled step-joint tab to create a splice joint region of an assembled multilayer mechanical belt.

### CROSS-REFERENCE TO RELATED APPLICATION(S)

This Application claims priority under 35 U.S.C. § 119(e) to U.S. Provisional Patent Application No. 63/214,996, entitled “SEAMLESS ADHESIVE JOINTS AND MECHANICAL BELTS INCLUDING SEAMLESS ADHESIVE JOINTS,” by Dahlia AMATO et al., filed Jun. 25, 2021, which is assigned to the current assignee hereof and incorporated herein by reference in its entirety.

### FIELD OF THE DISCLOSURE

The present disclosure relates to an unassembled multilayer mechanical belt, or an assembled multilayer mechanical belt, that is includes a seamless adhesive joint with improved strength.

### BACKGROUND

Mechanical belts often include joints from two adhesive tapes that use a stepped belt splice design. Typically, one side of the belt is wrapped around metal/rubber rolls, while the other side is exposed to chemicals such as polymers, resins, etc. However, such joints often fail leading to catastrophic failure during a process using the mechanical belt, such as extrusion. Joint failure can be caused by a low joint strength, improperly selected backings that cannot withstand the pressures exerted by the rolls, or thermochemical environments created on the material processing side that weaken the belt strength. Accordingly, mechanical belts with improved joint designs that have improved strength properties are desired.

### SUMMARY

According to a first aspect, an unassembled multilayer mechanical belt may include a first angled step-joint tab, a second angled step-joint tab, and a central overlap region between the first angled step-joint tab and the second angled step-joint tab. The central overlap region may include a first mechanical belt material layer overlying and adhered to a second mechanical belt material. The first angled step-joint tab may include a first tab backing material and a first tab adhesive material. The second angled step-joint tab may include a second tab backing material and a second tab adhesive material. The first angled step-joint tab may be configured to overlap with and adhere to the second angled step-joint tab to create a splice joint region of an assembled multilayer mechanical belt.

According to another aspect, a multilayer mechanical belt may include a spliced joint region and a central overlap region. The central overlap region may include a first mechanical belt material layer overlying and adhered to a second mechanical belt material layer. The spliced joint region may include a first angled step-joint tab extending from the first mechanical belt material layer and a second angled step-joint tab extending from the second mechanical belt material layer. The first angled step-joint tab may include a first tab backing material and a first tab adhesive material. The second angled step-joint tab may include a second tab backing material and a second tab adhesive material. The first angled step-joint tab overlaps with and adheres to the second angled step-joint tab.

### BRIEF DESCRIPTION OF THE DRAWINGS

Embodiments are illustrated by way of example and are not limited to the accompanying figures.

FIG. 1 includes an illustration of an example unassembled mechanical belt according to certain embodiments described herein;

FIG. 2 includes an illustration of an example unassembled mechanical belt according to certain embodiments described herein;

FIG. 3 includes an illustration of an example mechanical belt according to certain embodiments described herein;

FIG. 4 includes an illustration of an example mechanical belt according to certain embodiments described herein;

FIG. 5 includes a bar graph demonstrating the break strength performance of sample multilayer mechanical belts formed according to embodiments described herein as compared comparative sample multilayer mechanical belts;

FIG. 6 includes a bar graph demonstrating the break strength performance of sample multilayer mechanical belts formed according to embodiments described herein;

FIG. 7 includes a bar graph demonstrating the break strength performance of sample multilayer mechanical belts formed according to embodiments described herein as compared comparative sample multilayer mechanical belts.

Skilled artisans appreciate that elements in the figures are illustrated for simplicity and clarity and have not necessarily been drawn to scale.

### DETAILED DESCRIPTION

The following discussion will focus on specific implementations and embodiments of the teachings. The detailed description is provided to assist in describing certain embodiments and should not be interpreted as a limitation on the scope or applicability of the disclosure or teachings. It will be appreciated that other embodiments can be used based on the disclosure and teachings as provided herein.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Embodiments described herein are generally directed to an unassembled multilayer mechanical belt that may include a first angled step-joint tab, a second angled step-joint tab, and a central overlap region between the first angled step-joint tab and the second angled step-joint tab.

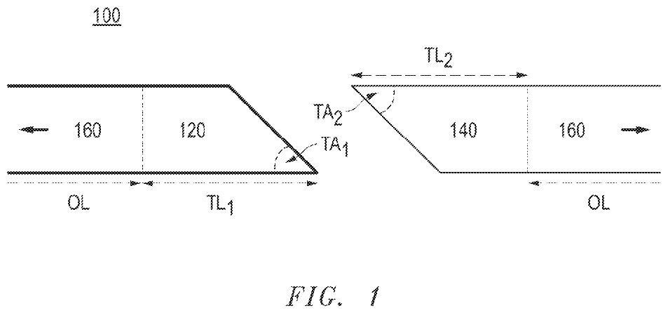

For purposes of illustration, FIG. 1 shows a top view of an unassembled multilayer mechanical belt 100 according to embodiments described herein. As shown in FIG. 1, the unassembled multilayer mechanical belt 100 may include a first angled step-joint tab 120, a second angled step-joint tab 140, and a central overlap region 160 between the first angled step-joint tab 120 and the second angled step-joint tab 120. According to particular embodiments, the first angled step-joint tab 120 may be configured to overlap with and adhere to the second angled step-joint tab 140.

According to particular embodiments, the first angled step-joint tab 120 may be configured to overlap with and adhere to the second angled step-joint tab 140 to create a spliced joint region when the unassembled multilayer mechanical belt 100 is converted into an assemble multilayer mechanical belt.

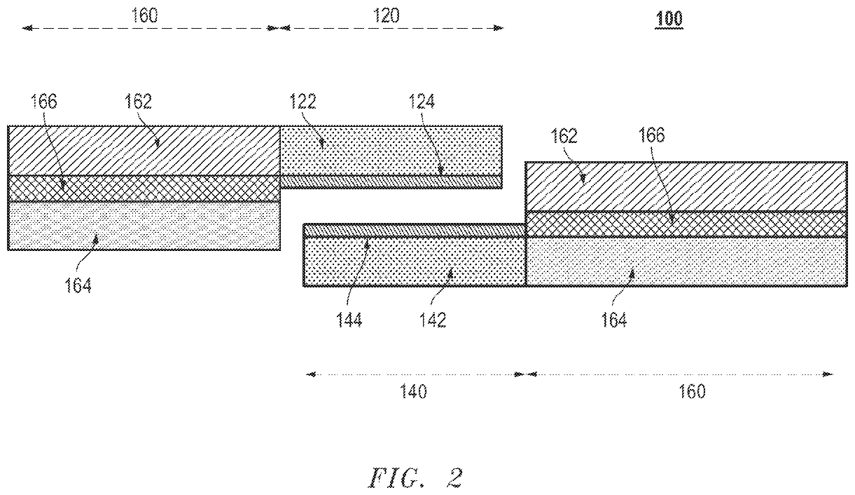

As further shown in FIG. 1, according to certain embodiments the first angled step-joint tab 120 may be described as having a particular tip angle TA₁ and a particular tab length TL₁. According to yet other embodiments and as shown in FIG. 2, the second angled step-joint tab 140 may be described as having a particular tip angle TA₂ and a particular tab length TL₂.

For purposes of further illustration, FIG. 2 shows a side view of the unassembled multilayer mechanical belt 100 according to embodiments described herein. As shown in FIG. 2, the first angled step-joint tab 120 may include a first tab backing material 122 and a first tab adhesive material 124. According to other embodiments and as shown in FIG. 2, the second angled step-joint tab 140 may have a second tab backing material 142 and a second tab adhesive material 142. As further shown in FIG. 2, the central overlap region 160 may include a first mechanical belt material layer 162 overlying and adhered to a second mechanical belt material layer 164 through a first central overlap region adhesive 166.

Again, according to particular embodiments, the first angled step-joint tab 120 may be configured to overlap with and adhere to the second angled step-joint tab 140 to create a spliced joint region when the unassembled multilayer mechanical belt is converted into an assemble multilayer mechanical belt. Specifically, and according to particular embodiments, the first tab adhesive material 124 of the first angled step-joint tab 120 may be configured to adhere to the second tab adhesive material 144 of the second angled step-joint tab 140. More specifically, and according to yet other embodiments, the first tab adhesive material 124 of the first angled step-joint tab 120 may be configured to adhere to the second tab adhesive material 144 of the second angled step-joint tab 140 to create a spliced joint region when the unassembled multilayer mechanical belt 100 is converted into an assemble multilayer mechanical belt.

According to certain embodiments, the first angled step-joint tab 120 may have a particular tip angle TA₁. For example, the tip angle TA₁ of the first angled step-joint tab 120 may be not greater than about 89°, such as, not greater than about 85° or not greater than about 80° or not greater than about 75° or not greater than about 70° or not greater than about 65° or not greater than about 60° or not greater than about 50° or not greater than about 45° or not greater than about 40° or not greater than about 35° or not greater than about 30° or not greater than about 25° or not greater than about 20° or even not greater than about 15°. According to still other embodiments, the tip angle TA₁ of the first angled step-joint tab 120 may be at least about 1°, such as, at least about 5° or at least about 10° or at least about 15° or at least about 20° or at least about 25° or at least about 30° or at least about 35° or at least about 40° or at least about 45° or at least about 50° or at least about 55° or at least about 60° or at least about 65° or at least about 70° or even at least about 75°. It will be appreciated that the tip angle TA₁ of the first angled step-joint tab 120 may be within a range between any of the values noted above. It will be further appreciated that the tip angle TA₁ of the first angled step-joint tab 120 may be any value between any of the values noted above.

According to certain embodiments, the second angled step-joint tab 140 may have a particular tip angle TA₂. For example, the tip angle TA₂ of the second angled step-joint tab 140 may be not greater than about 89°, such as, not greater than about 85° or not greater than about 80° or not greater than about 75° or not greater than about 70° or not greater than about 65° or not greater than about 60° or not greater than about 50° or not greater than about 45° or not greater than about 40° or not greater than about 35° or not greater than about 30° or not greater than about 25° or not greater than about 20° or even not greater than about 15°. According to still other embodiments, the tip angle TA₂ of the second angled step-joint tab 140 may be at least about 1°, such as, at least about 5° or at least about 10° or at least about 15° or at least about 20° or at least about 25° or at least about 30° or at least about 35° or at least about 40° or at least about 45° or at least about 50° or at least about 55° or at least about 60° or at least about 65° or at least about 70° or even at least about 75°. It will be appreciated that the tip angle TA₂ of the second angled step-joint tab 140 may be within a range between any of the values noted above. It will be further appreciated that the tip angle TA₂ of the second angled step-joint tab 140 may be any value between any of the values noted above.

According to yet other embodiments, the first angled step-joint 120 may have a particular tab length TL₁. For example, the tab length TL₁ of the first angled step-joint 120 may be at least about 30 mm, such as, at least about 35 mm or at least about 40 mm or at least about 45 mm or at least about 50 mm or at least about 55 mm or at least about 60 mm or at least about 70 mm or at least about 75 mm or at least about 80 mm or at least about 85 mm or at least about 90 mm or at least about 95 mm or at least about 100 mm or at least about 105 mm or at least about 110 mm or at least about 120 mm or at least about 130 mm or at least about 140 mm or at least about 145 mm or even at least about 150 mm. According to yet other embodiments, the tab length TL₁ of the first angled step-joint 120 may be not greater than about 1000 meters, such as, not greater than about 750 meters or not greater than about 500 meters or not greater than about 250 meters or not greater than about 100 meters or not greater than about 1 meter or not greater than about 750 mm or not greater than about 500 mm or not greater than about 250 mm or not greater than about 200 mm or not greater than about 195 mm or not greater than about 190 mm or not greater than about 185 mm or not greater than about 180 mm or not greater than about 175 mm or not greater than about 170 mm or not greater than about 165 mm or not greater than about 160 mm or not greater than about 155 mm or not greater than about 150 mm. It will be appreciated that the tab length TL₁ of the first angled step-joint 120 may be within a range between any of the values noted above. It will be further appreciated that the tab length TL₁ of the first angled step- joint 120 may be any value between any of the values noted above.

According to yet other embodiments, the second angled step-joint 140 may have a particular tab length TL₂. For example, the tab length TL₂ of the second angled step-joint 140 may be at least about 30 mm, such as, at least about 35 mm or at least about 40 mm or at least about 45 mm or at least about 50 mm or at least about 55 mm or at least about 60 mm or at least about 70 mm or at least about 75 mm or at least about 80 mm or at least about 85 mm or at least about 90 mm or at least about 95 mm or at least about 100 mm or at least about 105 mm or at least about 110 mm or at least about 120 mm or at least about 130 mm or at least about 140 mm or at least about 145 mm or even at least about 150 mm. According to yet other embodiments, the tab length TL₂ of the second angled step-joint 140 may be not greater than about 200 mm, such as, not greater than about 195 mm or not greater than about 190 mm or not greater than about 185 mm or not greater than about 180 mm or not greater than about 175 mm or not greater than about 170 mm or not greater than about 165 mm or not greater than about 160 mm or not greater than about 155 mm or even not greater than about 150 mm. It will be appreciated that the tab length TL₂ of the second angled step-joint 140 may be within a range between any of the values noted above. It will be further appreciated that the tab length TL₂ of the second angled step-joint 140 may be any value between any of the values noted above.

According to still other embodiments, the first angled step-joint tab 120 may have a particular tab thickness. For example, the thickness of the first angled step-joint tab 120 may be at least about 0.025 mm, such as, at least about 0.05 mm or at least about 0.075 mm or at least about 0.1 mm or at least about 0.5 mm or at least about 1 mm or at least about 2 mm or at least about 3 mm or at least about 4 mm or at least about 5 mm or at least about 6 mm or at least about 7 mm or at least about 8 mm or at least about 9 mm or even at least about 10 mm. According to yet other embodiments, the thickness of the second angled step-joint tab 120 may be not greater than about 30 mm, such as, not greater than about 29 mm or not greater than about 28 mm or not greater than about 27 mm or not greater than about 26 mm or not greater than about 25 mm or not greater than about 24 mm or not greater than about 23 mm or not greater than about 22 mm or not greater than about 21 mm or even not greater than about 20 mm. It will be appreciated that the thickness of the first angled step-joint tab 120 may be within a range between any of the values noted above. It will be further appreciated that the thickness of the first angled step-joint tab 120 may be any value between any of the values noted above.

According to still other embodiments, the second angled step-joint tab 140 may have a particular tab thickness. For example, the thickness of the second angled step-joint tab 140 may be at least about 0.025 mm, such as, at least about 0.05 mm or at least about 0.075 mm or at least about 0.1 mm or at least about 0.5 mm or at least about 1 mm or at least about 2 mm or at least about 3 mm or at least about 4 mm or at least about 5 mm or at least about 6 mm or at least about 7 mm or at least about 8 mm or at least about 9 mm or even at least about 10 mm. According to yet other embodiments, the thickness of the second angled step-joint tab 140 may be not greater than about 30 mm, such as, not greater than about 29 mm or not greater than about 28 mm or not greater than about 27 mm or not greater than about 26 mm or not greater than about 25 mm or not greater than about 24 mm or not greater than about 23 mm or not greater than about 22 mm or not greater than about 21 mm or even not greater than about 20 mm. It will be appreciated that the thickness of the second angled step-joint tab 140 may be within a range between any of the values noted above. It will be further appreciated that the thickness of the second angled step-joint tab 140 may be any value between any of the values noted above.

According to yet other embodiments, the unassembled multilayer mechanical belt 100 may include a particular region ratio SJ_{L}/OL_{L}, where SJ_{L} is the length of the spliced joint region that would be formed from the adhesion of the first angled step-joint tab 120 to the second angled step-joint tab 140 and OL_{L} is the length of the overlap region 160. For example, the unassembled multilayer mechanical belt 100 may have a region ratio SJ_{L}/OL_{L} of not greater than about 1, such as, not greater than about 0.5 or not greater than about 0.1 or not greater than about 0.05 or not greater than about 0.01 or not greater than about 0.005 or even not greater than about 0.001. According to still other embodiments, the unassembled multilayer mechanical belt 100 may have a region ratio SJ_{L}/OL_{L} of at least about 0.0001, such as, at least about 0.0005 or at least about 0.0009. It will be appreciated that the region ratio SJ_{L}/OL_{L} of the unassembled multilayer mechanical belt 100 may be within a range between any of the values noted above. It will be further appreciated that the region ratio SJ_{L}/OL_{L} of the unassembled multilayer mechanical belt 100 may be any value between any of the values noted above.

According to still other embodiments, the unassembled multilayer mechanical belt 100 may include a particular region ratio FT_{L}/OL_{L}, where FT_{L} is the length of the first angled step-joint tab 120 and OL_{L} is the length of the overlap region 160. For example, the unassembled multilayer mechanical belt 100 may have a region ratio FT_{L}/OL_{L} of not greater than about 1, such as, not greater than about 0.5 or not greater than about 0.1 or not greater than about 0.05 or not greater than about 0.01 or not greater than about 0.005 or even not greater than about 0.001. According to still other embodiments, the unassembled multilayer mechanical belt 100 may have a region ratio FT_{L}/OL_{L} of at least about 0.0001, such as, at least about 0.0005 or at least about 0.0009. It will be appreciated that the region ratio FT_{L}/OL_{L} of the unassembled multilayer mechanical belt 100 may be within a range between any of the values noted above. It will be further appreciated that the region ratio FT_{L}/OL_{L} of the unassembled multilayer mechanical belt 100 may be any value between any of the values noted above.

According to other embodiments, the unassembled multilayer mechanical belt 100 may include a particular region ratio ST_{L}/OL_{L}, where ST_{L} is the length of the second angled step-joint tab 130 and OL_{L} is the length of the overlap region 160. For example, the unassembled multilayer mechanical belt 100 may have a region ratio ST_{L}/OL_{L} of not greater than about 1, such as, not greater than about 0.5 or not greater than about 0.1 or not greater than about 0.05 or not greater than about 0.01 or not greater than about 0.005 or even not greater than about 0.001. According to still other embodiments, the unassembled multilayer mechanical belt 100 may have a region ratio ST_{L}/OL_{L} of at least about 0.0001, such as, at least about 0.0005 or at least about 0.0009. It will be appreciated that the region ratio ST_{L}/OL_{L} of the unassembled multilayer mechanical belt 100 may be within a range between any of the values noted above. It will be further appreciated that the region ratio ST_{L}/OL_{L} of the unassembled multilayer mechanical belt 100 may be any value between any of the values noted above.

According to yet other embodiments, the overlap region 160 may have a particular length. For example, the overlap region 160 may have a length of at least about 1 mm, such as, at least about 5 mm or at least about 10 mm or at least about 20 mm or at least about 30 mm or at least about 40 mm or at least about 50 mm or at least about 100 mm or least about 500 mm or at least about 1 meter or at least about 5 meters or at least about 10 meters or at least about 100 meters or at least about 500 meters or even at least about 1000 meters. According to still other embodiments, the overlap region 160 may have a length of not greater than about 2000 meters or not greater than about 1750 meters or not greater than about 1500 meters or even not greater than about 1250 meters. It will be appreciated that the length of the overlap region 160 may be within a range between any of the values noted above. It will be further appreciated that the length of the overlap region 160 may be any value between any of the values noted above.

According to yet other embodiments, the spliced joint region formed when the unassembled multilayer mechanical belt 100 is converted into an assembled multilayer mechanical belt may have a particular length. For example, the spliced joint region may have a length of at least about 30 mm, such as, at least about 35 mm or at least about 40 mm or at least about 45 mm or at least about 50 mm or at least about 55 mm or at least about 60 mm or at least about 70 mm or at least about 75 mm or at least about 80 mm or at least about 85 mm or at least about 90 mm or at least about 95 mm or at least about 100 mm or at least about 105 mm or at least about 110 mm or at least about 120 mm or at least about 130 mm or at least about 140 mm or at least about 145 mm or even at least about 150 mm. According to still other embodiments, the spliced joint region may have a length of not greater than about 200 mm, such as, not greater than about 195 mm or not greater than about 190 mm or not greater than about 185 mm or not greater than about 180 mm or not greater than about 175 mm or not greater than about 170 mm or not greater than about 165 mm or not greater than about 160 mm or not greater than about 155 mm or not greater than about 150 mm. It will be appreciated that the length of the spliced joint region may be within a range between any of the values noted above. It will be further appreciated that the length of the spliced joint region may be any value between any of the values noted above.

According to yet other embodiments, the unassembled multilayer mechanical belt 100 may have a particular thickness. For example, the unassembled multilayer mechanical belt 100 may have a thickness of at least about 0.05 mm, such as, at least about 0.075 mm or at least about 0.1 mm or at least about 0.5 mm or at least about 1 mm or at least about 2 mm or at least about 3 mm or at least about 4 mm or at least about 5 mm or at least about 6 mm or at least about 7 mm or at least about 8 mm or at least about 9 mm or even at least about 10 mm. According to yet other embodiments, the thickness of the second angled step-joint tab 140 may be not greater than about 60 mm, such as, not greater than about 55 mm or not greater than about 50 mm or not greater than about 45 mm or not greater than about 40 mm or not greater than about 35 mm or not greater than about 30 mm or not greater than about 29 mm or not greater than about 28 mm or not greater than about 27 mm or not greater than about 26 mm or not greater than about 25 mm or not greater than about 24 mm or not greater than about 23 mm or not greater than about 22 mm or not greater than about 21 mm or even not greater than about 20 mm. It will be appreciated that the thickness of the unassembled multilayer mechanical belt 100 may be within a range between any of the values noted above. It will be further appreciated that the thickness of the unassembled multilayer mechanical belt 100 may be any value between any of the values noted above.

According to still other embodiments, the unassembled multilayer mechanical belt 100 may have a particular length. For example, the unassembled multilayer mechanical belt 100 may have a length of at least about 0.003 meters, such as, at least about 0.005 meters or at least about 0.01 meters or at least about 0.05 meters or at least about 0.1 meters or at least about 0.5 meters or at least about 1 meters or at least about 10 meters or at least about 20 meters or at least about 30 meters or at least about 40 meters or at least about 50 meters or at least about 60 meters or at least about 70 meters or at least about 80 meters or at least about 90 meters or at least about 100 meters or at least about 500 meters or even at least about 1000 meters. According to still other embodiments, the unassembled multilayer mechanical belt 100 may have a length of not greater than about 2000 meters, such as, not greater than about 1950 meters or not greater than about 1900 meters or not greater than about 1850 meters or not greater than about 1800 meters or not greater than about 1750 meters or not greater than about 1700 meters or not greater than about 1650 meters or not greater than about 1600 meters or not greater than about 1550 meters or not greater than about 1500 meters or not greater than about 1450 meters or not greater than about 1400 meters or not greater than about 1350 meters or not greater than about 1300 meters or even not greater than about 1250 meters. It will be appreciated that the length of the unassembled multilayer mechanical belt 100 may be within a range between any of the values noted above. It will be further appreciated that the length of the unassembled multilayer mechanical belt 100 may be any value between any of the values noted above.

According to still other embodiments, the multilayer mechanical belt formed when the unassembled multilayer mechanical belt 100 may have a particular length. For example, the multilayer mechanical belt may have a length of at least about 0.003 meters, such as, at least about 0.005 meters or at least about 0.01 meters or at least about 0.05 meters or at least about 0.1 meters or at least about 0.5 meters or at least about 1 meters or at least about 10 meters or at least about 20 meters or at least about 30 meters or at least about 40 meters or at least about 50 meters or at least about 60 meters or at least about 70 meters or at least about 80 meters or at least about 90 meters or at least about 100 meters or at least about 500 meters or even at least about 1000 meters. According to still other embodiments, the multilayer mechanical belt may have a length of not greater than about 2000 meters, such as, not greater than about 1950 meters or not greater than about 1900 meters or not greater than about 1850 meters or not greater than about 1800 meters or not greater than about 1750 meters or not greater than about 1700 meters or not greater than about 1650 meters or not greater than about 1600 meters or not greater than about 1550 meters or not greater than about 1500 meters or not greater than about 1450 meters or not greater than about 1400 meters or not greater than about 1350 meters or not greater than about 1300 meters or even not greater than about 1250 meters. It will be appreciated that the length of the multilayer mechanical belt may be within a range between any of the values noted above. It will be further appreciated that the length of the multilayer mechanical belt may be any value between any of the values noted above.

According to still other embodiments, the unassembled multilayer mechanical belt 100 may have a particular width. For example, the unassembled multilayer mechanical belt 100 may have a width of at least about 0.001 meters, such as, at least about 0.005 meters or at least about 0.01 meters or at least about 0.02 meters or at least about 0.03 meters or at least about 0.04 meters or at least about 0.05 meters or at least about 0.06 meters or at least about 0.07 meters or at least about 0.08 meters or at least about 0.09 meters or at least about 0.1 meters or at least about 0.2 meters or at least about 0.3 meters or at least about 0.4 meters or at least about 0.5 meters or at least about 0.6 meters or at least about 0.7 meters or at least about 0.8 meters or at least about 0.9 meters or even at least about 1 meters. According to still other embodiments, the unassembled multilayer mechanical belt 100 may have a length of not greater than about 2 meters, such as, not greater than about 1.95 meters or not greater than about 1.90 meters or not greater than about 1.85 meters or not greater than about 1.80 meters or not greater than about 1.75 meters or not greater than about 1.70 meters or not greater than about 1.65 meters or not greater than about 1.60 meters or not greater than about 1.55 meters or not greater than about 1.50 meters or not greater than about 1.45 meters or not greater than about 1.40 meters or not greater than about 1.35 meters or not greater than about 1.30 meters or even not greater than about 1.25 meters. It will be appreciated that the width of the unassembled multilayer mechanical belt 100 may be within a range between any of the values noted above. It will be further appreciated that the width of the unassembled multilayer mechanical belt 100 may be any value between any of the values noted above.

According to still other embodiments, the multilayer mechanical belt formed when the unassembled multilayer mechanical belt 100 may have a particular width. For example, the multilayer mechanical belt may have a width of at least about 0.001 meters, such as, at least about 0.005 meters or at least about 0.01 meters or at least about 0.02 meters or at least about 0.03 meters or at least about 0.04 meters or at least about 0.05 meters or at least about 0.06 meters or at least about 0.07 meters or at least about 0.08 meters or at least about 0.09 meters or at least about 0.1 meters or at least about 0.2 meters or at least about 0.3 meters or at least about 0.4 meters or at least about 0.5 meters or at least about 0.6 meters or at least about 0.7 meters or at least about 0.8 meters or at least about 0.9 meters or even at least about 1 meters. According to still other embodiments, the multilayer mechanical belt may have a width of not greater than about 2 meters, such as, not greater than about 1.95 meters or not greater than about 1.90 meters or not greater than about 1.85 meters or not greater than about 1.80 meters or not greater than about 1.75 meters or not greater than about 1.70 meters or not greater than about 1.65 meters or not greater than about 1.60 meters or not greater than about 1.55 meters or not greater than about 1.50 meters or not greater than about 1.45 meters or not greater than about 1.40 meters or not greater than about 1.35 meters or not greater than about 1.30 meters or even not greater than about 1.25 meters. It will be appreciated that the width of the multilayer mechanical belt may be within a range between any of the values noted above. It will be further appreciated that the width of the multilayer mechanical belt may be any value between any of the values noted above.

According to still other embodiments, the first mechanical belt material layer 162 may include a particular material. For example, the first mechanical belt material layer 162 may include cloth, vulcanized fiber, paper, nonwoven materials, fibrous reinforced thermoplastic backing, polymeric films, substrates containing hooked stems, looped fabrics, metal foils, mesh, foam backings, or laminated multilayer combinations thereof. According to particular embodiments, cloth backings can be untreated, saturated, pre-sized, backsized, porous, or sealed, and they may be woven or stitch bonded. According to still other embodiments, the cloth backings may include fibers or yarns of cotton, polyester, rayon, silk, nylon or blends thereof. According to yet other embodiments, the cloth backings can be provided as laminates with different backing materials described herein. According to other embodiments, paper backings also can be saturated, barrier coated, pre-sized, backsized, untreated, or fiber-reinforced. According to still other embodiments, the paper backings also can be provided as laminates with a different type of backing material. According to yet other embodiments, nonwoven backings include scrims and laminates to different backing materials mentioned herein. According to still other embodiments, the nonwovens may be formed of cellulosic fibers, synthetic fibers or blends thereof. Polymeric backings include polyolefin or polyester films. According to yet other embodiments, the polymeric backings can be provided as blown film, or as laminates of different types of polymeric materials, or laminates of polymeric films with a non-polymeric type of backing material. According to still other embodiments, the backing can also be a stem web used alone or incorporating a nonwoven, or as a laminate with a different type of backing. According to yet other embodiments, the loop fabric backing can be brushed nylon, brushed polyester, polyester stitched loop, and loop material laminated to a different type of backing material. According to still other embodiments, the foam backing may be a natural sponge material or polyurethane foam and the like. According to other embodiments, the foam backing also can be laminated to a different type of backing material. According to still other embodiments, the mesh backings can be made of polymeric or metal open-weave scrims.

According to still other embodiments, the first mechanical belt material layer 162 may have a particular thickness. For example, the thickness of the first mechanical belt material layer 162 may be at least about 0.025 mm, such as, at least about 0.05 mm or at least about 0.075 mm or at least about 0.1 mm or at least about 0.5 mm or at least about 1 mm or at least about 2 mm or at least about 3 mm or at least about 4 mm or at least about 5 mm or at least about 6 mm or at least about 7 mm or at least about 8 mm or at least about 9 mm or even at least about 10 mm. According to yet other embodiments, the thickness of the first mechanical belt material layer 162 may be not greater than about 30 mm, such as, not greater than about 29 mm or not greater than about 28 mm or not greater than about 27 mm or not greater than about 26 mm or not greater than about 25 mm or not greater than about 24 mm or not greater than about 23 mm or not greater than about 22 mm or not greater than about 21 mm or even not greater than about 20 mm. It will be appreciated that the thickness of the first mechanical belt material layer 162 may be within a range between any of the values noted above. It will be further appreciated that the thickness of the first mechanical belt material layer 162 may be any value between any of the values noted above.

According to still other embodiments, the second mechanical belt material layer 164 may include a particular material. For example, the second mechanical belt material layer 164 may include cloth, vulcanized fiber, paper, nonwoven materials, fibrous reinforced thermoplastic backing, polymeric films, substrates containing hooked stems, looped fabrics, metal foils, mesh, foam backings, or laminated multilayer combinations thereof. According to particular embodiments, cloth backings can be untreated, saturated, pre-sized, backsized, porous, or sealed, and they may be woven or stitch bonded. According to still other embodiments, the cloth backings may include fibers or yarns of cotton, polyester, rayon, silk, nylon or blends thereof. According to yet other embodiments, the cloth backings can be provided as laminates with different backing materials described herein. According to other embodiments, paper backings also can be saturated, barrier coated, pre-sized, backsized, untreated, or fiber-reinforced. According to still other embodiments, the paper backings also can be provided as laminates with a different type of backing material. According to yet other embodiments, nonwoven backings include scrims and laminates to different backing materials mentioned herein. According to still other embodiments, the nonwovens may be formed of cellulosic fibers, synthetic fibers or blends thereof. Polymeric backings include polyolefin or polyester films. According to yet other embodiments, the polymeric backings can be provided as blown film, or as laminates of different types of polymeric materials, or laminates of polymeric films with a non-polymeric type of backing material. According to still other embodiments, the backing can also be a stem web used alone or incorporating a nonwoven, or as a laminate with a different type of backing. According to yet other embodiments, the loop fabric backing can be brushed nylon, brushed polyester, polyester stitched loop, and loop material laminated to a different type of backing material. According to still other embodiments, the foam backing may be a natural sponge material or polyurethane foam and the like. According to other embodiments, the foam backing also can be laminated to a different type of backing material. According to still other embodiments, the mesh backings can be made of polymeric or metal open-weave scrims.

According to still other embodiments, the second mechanical belt material layer 164 may have a particular thickness. For example, the thickness of the second mechanical belt material layer 164 may be at least about 0.025 mm, such as, at least about 0.05 mm or at least about 0.075 mm or at least about 0.1 mm or at least about 0.5 mm or at least about 1 mm or at least about 2 mm or at least about 3 mm or at least about 4 mm or at least about 5 mm or at least about 6 mm or at least about 7 mm or at least about 8 mm or at least about 9 mm or even at least about 10 mm. According to yet other embodiments, the thickness of the second mechanical belt material layer 164 may be not greater than about 30 mm, such as, not greater than about 29 mm or not greater than about 28 mm or not greater than about 27 mm or not greater than about 26 mm or not greater than about 25 mm or not greater than about 24 mm or not greater than about 23 mm or not greater than about 22 mm or not greater than about 21 mm or even not greater than about 20 mm. It will be appreciated that the thickness of the second mechanical belt material layer 164 may be within a range between any of the values noted above. It will be further appreciated that the thickness of the second mechanical belt material layer 164 may be any value between any of the values noted above.

According to yet other embodiments, the unassembled multilayer mechanical belt 100 may have a particular thickness ratio FML_{T}/SML_{T}, where FML_{T} is the thickness of the first mechanical belt material layer and SML_{T} is the thickness of the second mechanical belt material layer. According to particular embodiments, the unassembled multilayer mechanical belt 100 may have a thickness ratio FML_{T}/SML_{T} of at least about 0.0008, such as, at least about 0.001 or at least about 0.005 or at least about 0.01 or at least about 0.05 or even at least about 0.1. It will be appreciated that the thickness ratio FML_{T}/SML_{T} of the unassembled multilayer mechanical belt 100 may be within a range between any of the values noted above. It will be further appreciated that the thickness ratio FML_{T}/SML_{T} of the unassembled multilayer mechanical belt 100 may be any value between any of the values noted above.

According to yet other embodiments, the first central overlap region adhesive 166 may have include a particular material. For example, the first central overlap region adhesive 166 may include epoxy, urethane, acrylic, silicone, rubber, natural rubber, phenolic resin, amino resin, aminoplast resin, phenol-formaldehyde, urea-formaldehyde, melamine-formaldehyde, styrene isoprene copolymers, styrene butadiene copolymers, acrylated isocyanurate resins, and mixtures thereof. According to still other embodiments, the first central overlap region adhesive 166 may consist of epoxy, urethane, acrylic, silicone, rubber, natural rubber, phenolic resin, amino resin, aminoplast resin, phenol-formaldehyde, urea-formaldehyde, melamine-formaldehyde, styrene isoprene copolymers, styrene butadiene copolymers, acrylated isocyanurate resins, and mixtures thereof. According to still other embodiments, the first central overlap region adhesive 166 may be a layer of epoxy, urethane, acrylic, silicone, rubber, natural rubber, phenolic resin, amino resin, aminoplast resin, phenol-formaldehyde, urea-formaldehyde, melamine-formaldehyde, styrene isoprene copolymers, styrene butadiene copolymers, acrylated isocyanurate resins, and mixtures thereof.

According to still other embodiments, the first central overlap region adhesive 166 may have a particular thickness. For example, the thickness of the first central overlap region adhesive 166 may be at least about 0.025 mm, such as, at least about 0.05 mm or at least about 0.075 mm or at least about 0.1 mm or at least about 0.5 mm or at least about 1 mm or at least about 2 mm or at least about 3 mm or at least about 4 mm or at least about 5 mm or at least about 6 mm or at least about 7 mm or at least about 8 mm or at least about 9 mm or even at least about 10 mm. According to yet other embodiments, the thickness of the first central overlap region adhesive 166 may be not greater than about 30 mm, such as, not greater than about 29 mm or not greater than about 28 mm or not greater than about 27 mm or not greater than about 26 mm or not greater than about 25 mm or not greater than about 24 mm or not greater than about 23 mm or not greater than about 22 mm or not greater than about 21 mm or even not greater than about 20 mm. It will be appreciated that the thickness of the first central overlap region adhesive 166 may be within a range between any of the values noted above. It will be further appreciated that the thickness of the first central overlap region adhesive 166 may be any value between any of the values noted above.

According to still other embodiments, the first tab backing material 122 may include a particular material. For example, the first tab backing material 122 may include cloth, vulcanized fiber, paper, nonwoven materials, fibrous reinforced thermoplastic backing, polymeric films, substrates containing hooked stems, looped fabrics, metal foils, mesh, foam backings, or laminated multilayer combinations thereof. According to particular embodiments, cloth backings can be untreated, saturated, pre-sized, backsized, porous, or sealed, and they may be woven or stitch bonded. According to still other embodiments, the cloth backings may include fibers or yarns of cotton, polyester, rayon, silk, nylon or blends thereof. According to yet other embodiments, the cloth backings can be provided as laminates with different backing materials described herein. According to other embodiments, paper backings also can be saturated, barrier coated, pre-sized, backsized, untreated, or fiber-reinforced. According to still other embodiments, the paper backings also can be provided as laminates with a different type of backing material. According to yet other embodiments, nonwoven backings include scrims and laminates to different backing materials mentioned herein. According to still other embodiments, the nonwovens may be formed of cellulosic fibers, synthetic fibers or blends thereof. Polymeric backings include polyolefin or polyester films. According to yet other embodiments, the polymeric backings can be provided as blown film, or as laminates of different types of polymeric materials, or laminates of polymeric films with a non-polymeric type of backing material. According to still other embodiments, the backing can also be a stem web used alone or incorporating a nonwoven, or as a laminate with a different type of backing. According to yet other embodiments, the loop fabric backing can be brushed nylon, brushed polyester, polyester stitched loop, and loop material laminated to a different type of backing material. According to still other embodiments, the foam backing may be a natural sponge material or polyurethane foam and the like. According to other embodiments, the foam backing also can be laminated to a different type of backing material. According to still other embodiments, the mesh backings can be made of polymeric or metal open-weave scrims.

According to still other embodiments, the first tab backing material 122 may have a particular thickness. For example, the thickness of the first tab backing material 122 may be at least about 0.001 mm, such as, at least about 0.005 mm or at least about 0.01 mm or at least about 0.05 mm or at least about 0.075 mm or at least about 0.1 mm or at least about 0.5 mm or at least about 1 mm or at least about 2 mm or at least about 3 mm or at least about 4 mm or at least about 5 mm or at least about 6 mm or at least about 7 mm or at least about 8 mm or at least about 9 mm or even at least about 10 mm. According to yet other embodiments, the thickness of the first tab backing material 122 may be not greater than about 30 mm, such as, not greater than about 29 mm or not greater than about 28 mm or not greater than about 27 mm or not greater than about 26 mm or not greater than about 25 mm or not greater than about 24 mm or not greater than about 23 mm or not greater than about 22 mm or not greater than about 21 mm or even not greater than about 20 mm. It will be appreciated that the thickness of the first tab backing material 122 may be within a range between any of the values noted above. It will be further appreciated that the thickness of the first tab backing material 122 may be any value between any of the values noted above.

According to still other embodiments, the first tab adhesive material 124 may include a particular material. For example, the first tab adhesive material 124 may include epoxy, urethane, acrylic, silicone, rubber, natural rubber, phenolic resin, amino resin, aminoplast resin, phenol-formaldehyde, urea-formaldehyde, melamine-formaldehyde, styrene isoprene copolymers, styrene butadiene copolymers, acrylated isocyanurate resins, and mixtures thereof. According to still other embodiments, the first tab adhesive material 124 may consist of epoxy, urethane, acrylic, silicone, rubber, natural rubber, phenolic resin, amino resin, aminoplast resin, phenol-formaldehyde, urea-formaldehyde, melamine-formaldehyde, styrene isoprene copolymers, styrene butadiene copolymers, acrylated isocyanurate resins, and mixtures thereof. According to yet other embodiments, the first tab adhesive material 124 may be a layer of epoxy, urethane, acrylic, silicone, rubber, natural rubber, phenolic resin, amino resin, aminoplast resin, phenol-formaldehyde, urea-formaldehyde, melamine-formaldehyde, styrene isoprene copolymers, styrene butadiene copolymers, acrylated isocyanurate resins, and mixtures thereof.

According to still other embodiments, the first tab adhesive material 124 may have a particular thickness. For example, the thickness of the first tab adhesive material 124 may be at least about 0.0125 mm, such as, at least about 0.025 mm or at least about 0.05 mm or at least about 0.075 mm or at least about 0.1 mm or at least about 0.5 mm or at least about 1 mm or at least about 2 mm or at least about 3 mm or at least about 4 mm or at least about 5 mm or at least about 6 mm or at least about 7 mm or at least about 8 mm or at least about 9 mm or even at least about 10 mm. According to yet other embodiments, the thickness of the first tab adhesive material 124 may be not greater than about 30 mm, such as, not greater than about 29 mm or not greater than about 28 mm or not greater than about 27 mm or not greater than about 26 mm or not greater than about 25 mm or not greater than about 24 mm or not greater than about 23 mm or not greater than about 22 mm or not greater than about 21 mm or even not greater than about 20 mm. It will be appreciated that the thickness of the first tab adhesive material 124 may be within a range between any of the values noted above. It will be further appreciated that the thickness of the first tab adhesive material 124 may be any value between any of the values noted above.

According to still other embodiments, the second tab backing material 142 may include a particular material. For example, the second tab backing material 142 may include cloth, vulcanized fiber, paper, nonwoven materials, fibrous reinforced thermoplastic backing, polymeric films, substrates containing hooked stems, looped fabrics, metal foils, mesh, foam backings, or laminated multilayer combinations thereof. According to particular embodiments, cloth backings can be untreated, saturated, pre-sized, backsized, porous, or sealed, and they may be woven or stitch bonded. According to still other embodiments, the cloth backings may include fibers or yarns of cotton, polyester, rayon, silk, nylon or blends thereof. According to yet other embodiments, the cloth backings can be provided as laminates with different backing materials described herein. According to other embodiments, paper backings also can be saturated, barrier coated, pre-sized, backsized, untreated, or fiber-reinforced. According to still other embodiments, the paper backings also can be provided as laminates with a different type of backing material. According to yet other embodiments, nonwoven backings include scrims and laminates to different backing materials mentioned herein. According to still other embodiments, the nonwovens may be formed of cellulosic fibers, synthetic fibers or blends thereof. Polymeric backings include polyolefin or polyester films. According to yet other embodiments, the polymeric backings can be provided as blown film, or as laminates of different types of polymeric materials, or laminates of polymeric films with a non-polymeric type of backing material. According to still other embodiments, the backing can also be a stem web used alone or incorporating a nonwoven, or as a laminate with a different type of backing. According to yet other embodiments, the loop fabric backing can be brushed nylon, brushed polyester, polyester stitched loop, and loop material laminated to a different type of backing material. According to still other embodiments, the foam backing may be a natural sponge material or polyurethane foam and the like. According to other embodiments, the foam backing also can be laminated to a different type of backing material. According to still other embodiments, the mesh backings can be made of polymeric or metal open-weave scrims.

According to still other embodiments, the second tab backing material 142 may have a particular thickness. For example, the thickness of the second tab backing material 142 may be at least about 0.001 mm, such as, at least about 0.005 mm or at least about 0.01 mm or at least about 0.05 mm or at least about 0.075 mm or at least about 0.1 mm or at least about 0.5 mm or at least about 1 mm or at least about 2 mm or at least about 3 mm or at least about 4 mm or at least about 5 mm or at least about 6 mm or at least about 7 mm or at least about 8 mm or at least about 9 mm or even at least about 10 mm. According to yet other embodiments, the thickness of the second tab backing material 142 may be not greater than about 30 mm, such as, not greater than about 29 mm or not greater than about 28 mm or not greater than about 27 mm or not greater than about 26 mm or not greater than about 25 mm or not greater than about 24 mm or not greater than about 23 mm or not greater than about 22 mm or not greater than about 21 mm or even not greater than about 20 mm. It will be appreciated that the thickness of the second tab backing material 142 may be within a range between any of the values noted above. It will be further appreciated that the thickness of the second tab backing material 142 may be any value between any of the values noted above.

According to still other embodiments, the second tab adhesive material 144 may include a particular material. For example, the second tab adhesive material 144 may include epoxy, urethane, acrylic, silicone, rubber, natural rubber, phenolic resin, amino resin, aminoplast resin, phenol-formaldehyde, urea-formaldehyde, melamine-formaldehyde, styrene isoprene copolymers, styrene butadiene copolymers, acrylated isocyanurate resins, and mixtures thereof. According to still other embodiments, the second tab adhesive material 144 may consist of epoxy, urethane, acrylic, silicone, rubber, natural rubber, phenolic resin, amino resin, aminoplast resin, phenol-formaldehyde, urea-formaldehyde, melamine-formaldehyde, styrene isoprene copolymers, styrene butadiene copolymers, acrylated isocyanurate resins, and mixtures thereof. According to yet other embodiments, the second tab adhesive material 144 may be a layer of epoxy, urethane, acrylic, silicone, rubber, natural rubber, phenolic resin, amino resin, aminoplast resin, phenol-formaldehyde, urea-formaldehyde, melamine-formaldehyde, styrene isoprene copolymers, styrene butadiene copolymers, acrylated isocyanurate resins, and mixtures thereof.

According to still other embodiments, the second tab adhesive material 144 may have a particular thickness. For example, the thickness of the second tab adhesive material 144 may be at least about 0.0125 mm, such as, at least about 0.025 mm or at least about 0.05 mm or at least about 0.075 mm or at least about 0.1 mm or at least about 0.5 mm or at least about 1 mm or at least about 2 mm or at least about 3 mm or at least about 4 mm or at least about 5 mm or at least about 6 mm or at least about 7 mm or at least about 8 mm or at least about 9 mm or even at least about 10 mm. According to yet other embodiments, the thickness of the first central overlap region adhesive 166 may be not greater than about 30 mm, such as, not greater than about 29 mm or not greater than about 28 mm or not greater than about 27 mm or not greater than about 26 mm or not greater than about 25 mm or not greater than about 24 mm or not greater than about 23 mm or not greater than about 22 mm or not greater than about 21 mm or even not greater than about 20 mm. It will be appreciated that the thickness of the second tab adhesive material 144 may be within a range between any of the values noted above. It will be further appreciated that the thickness of the second tab adhesive material 144 may be any value between any of the values noted above.

According to still other embodiments, the spliced joint region formed when the unassembled multilayer mechanical belt 100 is assembled may have a particular breaking strength increase rating, where the break strength increase rating is defined as the percent increase in break strength of the spliced joint region formed from the first angled step-joint tab, and the second angled step-joint tab as compared to the break strength of a spliced joint region having two non-angled step-joint tabs and where break strength is measured according to ASTM D1002. For example, the spliced joint region may have a break strength increase rating of at least about 10%, such as, at least about 15% or at least about 20% or at least about 25% or at least about 30% or at least about 35% or at least about 40% or at least about 45% or even at least about 50%. It will be appreciated that the break strength increase rating of the spliced joint region may be within a range between any of the values noted above. It will be further appreciated that the break strength increase rating of the spliced joint region may be any value between any of the values noted above.

According to still other embodiments, the spliced joint region formed when the unassembled multilayer mechanical belt 100 is assembled may have a particular breaking strength as measured according to ASTM D1002. For example, the spliced joint region may have a break strength of at least about 360 N, such as, at least about 370 N or at least about 380 N or at least about 390 N or at least about 400 N or at least about 410 N or at least about 420 N or at least about 430 N or at least about 440 N or at least about 450 N or even at least about 500 N. According to yet other embodiments, the spliced joint region may have a break strength of not greater than about 1,000,000 N, such as, not greater than about 100,000 N or even not greater than about 10,000 N. It will be appreciated that the break strength of the spliced joint region may be within a range between any of the values noted above. It will be further appreciated that the break strength of the spliced joint region may be any value between any of the values noted above.

Turning now to the multilayer mechanical belt formed when embodiments of the unassembled multilayer mechanical belt described herein are assemble, additional embodiments, described herein are generally directed to a multilayer mechanical belt that may include a spliced join region and a central overlap region. The spliced join region may include a first angled step- joint tab, a second angled step-joint tab, and a central overlap region between the first angled step-joint tab and the second angled step-joint tab.

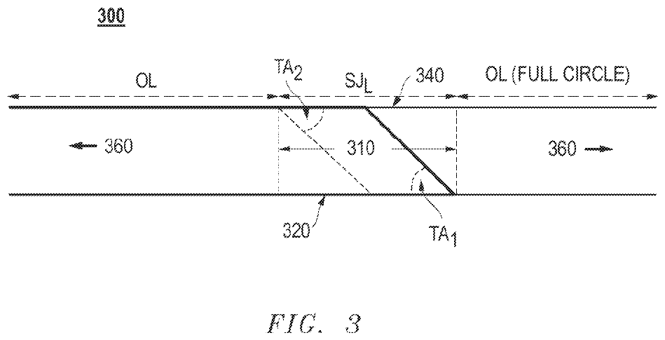

For purposes of illustration, FIG. 3 shows a top view of a multilayer mechanical belt 300 according to embodiments described herein. As shown in FIG. 3, the multilayer mechanical belt 300 may include a spliced joint region 310 and a central overlap region 360. According to certain embodiments and as further shown in FIG. 3, the spliced joint region 310 may include a first angled step-joint tab 320, and a second angled step-joint tab 340. According to particular embodiments, the first angled step-joint tab 320 may overlap with and adhere to the second angled step-joint tab 340.

According to certain embodiments and as shown in FIG. 3, the first angled step-joint tab 320 may be described as having a particular tip angle TA₁ and a particular tab length TL₁. According to yet other embodiments and as shown in FIG. 3, the second angled step-joint tab 340 may be described as having a particular tip angle TA₂ and a particular tab length TL₂.

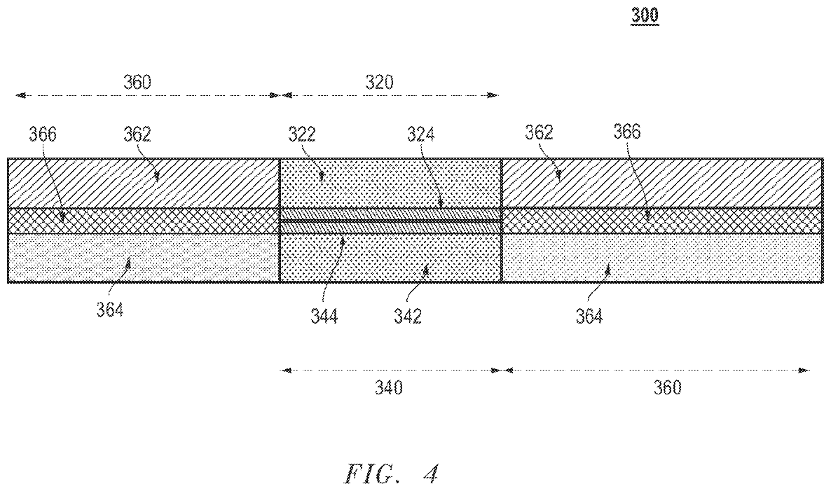

For purposes of further illustration, FIG. 4 shows a side view of the multilayer mechanical belt 300 according to embodiments described herein. As shown in FIG. 4, the first angled step-joint tab 320 may include a first tab backing material 322 and a first tab adhesive material 324. According to other embodiments and as shown in FIG. 4, the second angled step- joint tab 340 may have a second tab backing material 342 and a second tab adhesive material 344. As further shown in FIG. 4, the central overlap region may include a first mechanical belt material layer 362 overlying and adhered to a second mechanical belt material layer 364 through a first central overlap region adhesive 366.

According to certain embodiments, the first angled step-joint tab 320 may have a particular tip angle TA₁. For example, the tip angle TA₁ of the first angled step-joint tab 320 may be not greater than about 89°, such as, not greater than about 85° or not greater than about 80° or not greater than about 75° or not greater than about 70° or not greater than about 65° or not greater than about 60° or not greater than about 50° or not greater than about 45° or not greater than about 40° or not greater than about 35° or not greater than about 30° or not greater than about 25° or not greater than about 20° or even not greater than about 15°. According to still other embodiments, the tip angle TA₁ of the first angled step-joint tab 320 may be at least about 1°, such as, at least about 5° or at least about 10° or at least about 15° or at least about 20° or at least about 25° or at least about 30° or at least about 35° or at least about 40° or at least about 45° or at least about 50° or at least about 55° or at least about 60° or at least about 65° or at least about 70° or even at least about 75°. It will be appreciated that the tip angle TA₁ of the first angled step-joint tab 320 may be within a range between any of the values noted above. It will be further appreciated that the tip angle TA₁ of the first angled step-joint tab 320 may be any value between any of the values noted above.

According to certain embodiments, the second angled step-joint tab 340 may have a particular tip angle TA₂. For example, the tip angle TA₂ of the second angled step-joint tab 340 may be not greater than about 89°, such as, not greater than about 85° or not greater than about 80° or not greater than about 75° or not greater than about 70° or not greater than about 65° or not greater than about 60° or not greater than about 50° or not greater than about 45° or not greater than about 40° or not greater than about 35° or not greater than about 30° or not greater than about 25° or not greater than about 20° or even not greater than about 15°. According to still other embodiments, the tip angle TA₂ of the second angled step-joint tab 340 may be at least about 1°, such as, at least about 5° or at least about 10° or at least about 15° or at least about 20° or at least about 25° or at least about 30° or at least about 35° or at least about 40° or at least about 45° or at least about 50° or at least about 55° or at least about 60° or at least about 65° or at least about 70° or even at least about 75°. It will be appreciated that the tip angle TA₂ of the second angled step-joint tab 340 may be within a range between any of the values noted above. It will be further appreciated that the tip angle TA₂ of the second angled step-joint tab 340 may be any value between any of the values noted above.

According to yet other embodiments, the first angled step-joint 320 may have a particular tab length TL₁. For example, the tab length TL₁ of the first angled step-joint 320 may be at least about 30 mm, such as, at least about 35 mm or at least about 40 mm or at least about 45 mm or at least about 50 mm or at least about 55 mm or at least about 60 mm or at least about 70 mm or at least about 75 mm or at least about 80 mm or at least about 85 mm or at least about 90 mm or at least about 95 mm or at least about 100 mm or at least about 105 mm or at least about 110 mm or at least about 320 mm or at least about 130 mm or at least about 340 mm or at least about 145 mm or even at least about 150 mm. According to yet other embodiments, the tab length TL₁ of the first angled step-joint 320 may be not greater than about 1000 meters, such as, not greater than about 750 meters or not greater than about 500 meters or not greater than about 250 meters or not greater than about 100 meters or not greater than about 1 meter or not greater than about 750 mm or not greater than about 500 mm or not greater than about 250 mm or not greater than about 200 mm or not greater than about 195 mm or not greater than about 190 mm or not greater than about 185 mm or not greater than about 180 mm or not greater than about 175 mm or not greater than about 170 mm or not greater than about 165 mm or not greater than about 160 mm or not greater than about 155 mm or even not greater than about 150 mm. It will be appreciated that the tab length TL₁ of the first angled step-joint 320 may be within a range between any of the values noted above. It will be further appreciated that the tab length TL₁ of the first angled step-joint 320 may be any value between any of the values noted above.

According to yet other embodiments, the second angled step-joint 340 may have a particular tab length TL₂. For example, the tab length TL₂ of the second angled step-joint 340 may be at least about 30 mm, such as, at least about 35 mm or at least about 40 mm or at least about 45 mm or at least about 50 mm or at least about 55 mm or at least about 60 mm or at least about 70 mm or at least about 75 mm or at least about 80 mm or at least about 85 mm or at least about 90 mm or at least about 95 mm or at least about 100 mm or at least about 105 mm or at least about 110 mm or at least about 320 mm or at least about 130 mm or at least about 340 mm or at least about 145 mm or even at least about 150 mm. According to yet other embodiments, the tab length TL₂ of the second angled step-joint 340 may be not greater than about 200 mm, such as, not greater than about 195 mm or not greater than about 190 mm or not greater than about 185 mm or not greater than about 180 mm or not greater than about 175 mm or not greater than about 170 mm or not greater than about 165 mm or not greater than about 160 mm or not greater than about 155 mm or even not greater than about 150 mm. It will be appreciated that the tab length TL₂ of the second angled step-joint 340 may be within a range between any of the values noted above. It will be further appreciated that the tab length TL₂ of the second angled step-joint 340 may be any value between any of the values noted above.

According to still other embodiments, the first angled step-joint tab 320 may have a particular tab thickness. For example, the thickness of the first angled step-joint tab 320 may be at least about 0.025 mm, such as, at least about 0.05 mm or at least about 0.075 mm or at least about 0.1 mm or at least about 0.5 mm or at least about 1 mm or at least about 2 mm or at least about 3 mm or at least about 4 mm or at least about 5 mm or at least about 6 mm or at least about 7 mm or at least about 8 mm or at least about 9 mm or even at least about 10 mm. According to yet other embodiments, the thickness of the second angled step-joint tab 320 may be not greater than about 30 mm, such as, not greater than about 29 mm or not greater than about 28 mm or not greater than about 27 mm or not greater than about 26 mm or not greater than about 25 mm or not greater than about 24 mm or not greater than about 23 mm or not greater than about 22 mm or not greater than about 21 mm or even not greater than about 20 mm. It will be appreciated that the thickness of the first angled step-joint tab 320 may be within a range between any of the values noted above. It will be further appreciated that the thickness of the first angled step-joint tab 320 may be any value between any of the values noted above.

According to still other embodiments, the second angled step-joint tab 340 may have a particular tab thickness. For example, the thickness of the second angled step-joint tab 340 may be at least about 0.025 mm, such as, at least about 0.05 mm or at least about 0.075 mm or at least about 0.1 mm or at least about 0.5 mm or at least about 1 mm or at least about 2 mm or at least about 3 mm or at least about 4 mm or at least about 5 mm or at least about 6 mm or at least about 7 mm or at least about 8 mm or at least about 9 mm or even at least about 10 mm. According to yet other embodiments, the thickness of the second angled step-joint tab 340 may be not greater than about 30 mm, such as, not greater than about 29 mm or not greater than about 28 mm or not greater than about 27 mm or not greater than about 26 mm or not greater than about 25 mm or not greater than about 24 mm or not greater than about 23 mm or not greater than about 22 mm or not greater than about 21 mm or even not greater than about 20 mm. It will be appreciated that the thickness of the second angled step-joint tab 340 may be within a range between any of the values noted above. It will be further appreciated that the thickness of the second angled step- joint tab 340 may be any value between any of the values noted above.

According to yet other embodiments, the multilayer mechanical belt 300 may include a particular region ratio SJ_{L}/OL_{L}, where SJ_{L} is the length of the spliced joint region 310 and OL_{L} is the length of the overlap region 360. For example, the multilayer mechanical belt 300 may have a region ratio SJ_{L}/OL_{L} of not greater than about 1, such as, not greater than about 0.5 or not greater than about 0.1 or not greater than about 0.05 or not greater than about 0.01 or not greater than about 0.005 or even not greater than about 0.001. According to still other embodiments, the multilayer mechanical belt 300 may have a region ratio SJ_{L}/OL_{L} of at least about 0.0001, such as, at least about 0.0005 or at least about 0.0009. It will be appreciated that the region ratio SJ_{L}/OL_{L} of the multilayer mechanical belt 300 may be within a range between any of the values noted above. It will be further appreciated that the region ratio SJ_{L}/OL_{L} of the multilayer mechanical belt 300 may be any value between any of the values noted above.

According to still other embodiments, the multilayer mechanical belt 300 may include a particular region ratio FT_{L}/OL_{L}, where FT_{L} is the length of the first angled step-joint tab 320 and OL_{L} is the length of the overlap region 360. For example, the multilayer mechanical belt 300 may have a region ratio FT_{L}/OL_{L} of not greater than about 1, such as, not greater than about 0.5 or not greater than about 0.1 or not greater than about 0.05 or not greater than about 0.01 or not greater than about 0.005 or even not greater than about 0.001. According to still other embodiments, the multilayer mechanical belt 300 may have a region ratio FT_{L}/OL_{L} of at least about 0.0001, such as, at least about 0.0005 or at least about 0.0009. It will be appreciated that the region ratio FT_{L}/OL_{L} of the multilayer mechanical belt 300 may be within a range between any of the values noted above. It will be further appreciated that the region ratio FT_{L}OL_{L} of the multilayer mechanical belt 300 may be any value between any of the values noted above.

According to other embodiments, the multilayer mechanical belt 300 may include a particular region ratio ST_{L}/OL_{L}, where ST_{L} is the length of the second angled step-joint tab 130 and OL_{L} is the length of the overlap region 360. For example, the multilayer mechanical belt 300 may have a region ratio ST_{L}/OL_{L} of not greater than about 1, such as, not greater than about 0.5 or not greater than about 0.1 or not greater than about 0.05 or not greater than about 0.01 or not greater than about 0.005 or even not greater than about 0.001. According to still other embodiments, the multilayer mechanical belt 300 may have a region ratio ST_{L}/OL_{L} of at least about 0.0001, such as, at least about 0.0005 or at least about 0.0009. It will be appreciated that the region ratio ST_{L}/OL_{L} of the multilayer mechanical belt 300 may be within a range between any of the values noted above. It will be further appreciated that the region ratio ST_{L}/OL_{L} of the multilayer mechanical belt 300 may be any value between any of the values noted above.

According to yet other embodiments, the overlap region 360 may have a particular length. For example, the overlap region 360 may have a length of at least about 1 mm, such as, at least about 5 mm or at least about 10 mm or at least about 20 mm or at least about 30 mm or at least about 40 mm or at least about 50 mm or at least about 100 mm or least about 500 mm or at least about 1 meter or at least about 5 meters or at least about 10 meters or at least about 100 meters or at least about 500 meters or even at least about 1000 meters. According to still other embodiments, the overlap region 360 may have a length of not greater than about 2000 meters or not greater than about 1750 meters or not greater than about 1500 meters or even not greater than about 1250 meters. It will be appreciated that the length of the overlap region 360 may be within a range between any of the values noted above. It will be further appreciated that the length of the overlap region 360 may be any value between any of the values noted above.

According to yet other embodiments, the spliced joint region 310 may have a particular length. For example, the spliced joint region 310 may have a length of at least about 30 mm, such as, at least about 35 mm or at least about 40 mm or at least about 45 mm or at least about 50 mm or at least about 55 mm or at least about 60 mm or at least about 70 mm or at least about 75 mm or at least about 80 mm or at least about 85 mm or at least about 90 mm or at least about 95 mm or at least about 100 mm or at least about 105 mm or at least about 110 mm or at least about 320 mm or at least about 130 mm or at least about 340 mm or at least about 145 mm or even at least about 150 mm. According to still other embodiments, the spliced joint region 310 may have a length of not greater than about 1000 meters, such as, not greater than about 750 meters or not greater than about 500 meters or not greater than about 250 meters or not greater than about 100 meters or not greater than about 1 meter or not greater than about 750 mm or not greater than about 500 mm or not greater than about 250 mm or not greater than about 200 mm or not greater than about 195 mm or not greater than about 190 mm or not greater than about 185 mm or not greater than about 180 mm or not greater than about 175 mm or not greater than about 170 mm or not greater than about 165 mm or not greater than about 160 mm or not greater than about 155 mm or even not greater than about 150 mm. It will be appreciated that the length of the spliced joint region 310 may be within a range between any of the values noted above. It will be further appreciated that the length of the spliced joint region 310 may be any value between any of the values noted above.

According to yet other embodiments, the multilayer mechanical belt 300 may have a particular thickness. For example, the multilayer mechanical belt 300 may have a thickness of at least about 0.05 mm, such as, at least about 0.075 mm or at least about 0.1 mm or at least about 0.5 mm or at least about 1 mm or at least about 2 mm or at least about 3 mm or at least about 4 mm or at least about 5 mm or at least about 6 mm or at least about 7 mm or at least about 8 mm or at least about 9 mm or even at least about 10 mm. According to yet other embodiments, the thickness of the second angled step-joint tab 340 may be not greater than about 60 mm, such as, not greater than about 55 mm or not greater than about 50 mm or not greater than about 45 mm or not greater than about 40 mm or not greater than about 35 mm or not greater than about 30 mm or not greater than about 29 mm or not greater than about 28 mm or not greater than about 27 mm or not greater than about 26 mm or not greater than about 25 mm or not greater than about 24 mm or not greater than about 23 mm or not greater than about 22 mm or not greater than about 21 mm or even not greater than about 20 mm. It will be appreciated that the thickness of the multilayer mechanical belt 300 may be within a range between any of the values noted above. It will be further appreciated that the thickness of the multilayer mechanical belt 300 may be any value between any of the values noted above.

According to still other embodiments, the multilayer mechanical belt 300 may have a particular length. For example, the multilayer mechanical belt 300 may have a length of at least about 0.003 m, such as, at least about 0.005 meters or at least about 0.01 meters or at least about 0.05 meters or at least about 0.1 meters or at least about 0.5 meters or at least about 1 meters or at least about 10 meters or at least about 20 meters or at least about 30 meters or at least about 40 meters or at least about 50 meters or at least about 60 meters or at least about 70 meters or at least about 80 meters or at least about 90 meters or at least about 100 meters or at least about 500 meters or even at least about 1000 meters. According to still other embodiments, the multilayer mechanical belt 300 may have a length of not greater than about 2000 meters, such as, not greater than about 1950 meters or not greater than about 1900 meters or not greater than about 1850 meters or not greater than about 1800 meters or not greater than about 1750 meters or not greater than about 1700 meters or not greater than about 1650 meters or not greater than about 3600 meters or not greater than about 1550 meters or not greater than about 1500 meters or not greater than about 1450 meters or not greater than about 4300 meters or not greater than about 1350 meters or not greater than about 1300 meters or even not greater than about 1250 meters. It will be appreciated that the length of the multilayer mechanical belt 300 may be within a range between any of the values noted above. It will be further appreciated that the length of the multilayer mechanical belt 300 may be any value between any of the values noted above.

According to still other embodiments, the multilayer mechanical belt 300 may have a particular width. For example, the multilayer mechanical belt 300 may have a width of at least about 0.001 meters, such as, at least about 0.005 meters or at least about 0.01 meters or at least about 0.02 meters or at least about 0.03 meters or at least about 0.04 meters or at least about 0.05 meters or at least about 0.06 meters or at least about 0.07 meters or at least about 0.08 meters or at least about 0.09 meters or at least about 0.1 meters or at least about 0.2 meters or at least about 0.3 meters or at least about 0.4 meters or at least about 0.5 meters or at least about 0.6 meters or at least about 0.7 meters or at least about 0.8 meters or at least about 0.9 meters or even at least about 1 meters. According to still other embodiments, the multilayer mechanical belt 300 may have a length of not greater than about 2 meters, such as, not greater than about 1.95 meters or not greater than about 1.90 meters or not greater than about 1.85 meters or not greater than about 1.80 meters or not greater than about 1.75 meters or not greater than about 1.70 meters or not greater than about 1.65 meters or not greater than about 1.60 meters or not greater than about 1.55 meters or not greater than about 1.50 meters or not greater than about 1.45 meters or not greater than about 1.40 meters or not greater than about 1.35 meters or not greater than about 1.30 meters or even not greater than about 1.25 meters. It will be appreciated that the width of the multilayer mechanical belt 300 may be within a range between any of the values noted above. It will be further appreciated that the width of the multilayer mechanical belt 300 may be any value between any of the values noted above.

According to still other embodiments, the first mechanical belt material layer 362 may include a particular material. For example, the first mechanical belt material layer 362 may include cloth, vulcanized fiber, paper, nonwoven materials, fibrous reinforced thermoplastic backing, polymeric films, substrates containing hooked stems, looped fabrics, metal foils, mesh, foam backings, or laminated multilayer combinations thereof. According to particular embodiments, cloth backings can be untreated, saturated, pre-sized, backsized, porous, or sealed, and they may be woven or stitch bonded. According to still other embodiments, the cloth backings may include fibers or yarns of cotton, polyester, rayon, silk, nylon or blends thereof. According to yet other embodiments, the cloth backings can be provided as laminates with different backing materials described herein. According to other embodiments, paper backings also can be saturated, barrier coated, pre-sized, backsized, untreated, or fiber-reinforced. According to still other embodiments, the paper backings also can be provided as laminates with a different type of backing material. According to yet other embodiments, nonwoven backings include scrims and laminates to different backing materials mentioned herein. According to still other embodiments, the nonwovens may be formed of cellulosic fibers, synthetic fibers or blends thereof. Polymeric backings include polyolefin or polyester films. According to yet other embodiments, the polymeric backings can be provided as blown film, or as laminates of different types of polymeric materials, or laminates of polymeric films with a non-polymeric type of backing material. According to still other embodiments, the backing can also be a stem web used alone or incorporating a nonwoven, or as a laminate with a different type of backing. According to yet other embodiments, the loop fabric backing can be brushed nylon, brushed polyester, polyester stitched loop, and loop material laminated to a different type of backing material. According to still other embodiments, the foam backing may be a natural sponge material or polyurethane foam and the like. According to other embodiments, the foam backing also can be laminated to a different type of backing material. According to still other embodiments, the mesh backings can be made of polymeric or metal open-weave scrims.

According to still other embodiments, the first mechanical belt material layer 362 may have a particular thickness. For example, the thickness of the first mechanical belt material layer 362 may be at least about 0.025 mm, such as, at least about 0.05 mm or at least about 0.075 mm or at least about 0.1 mm or at least about 0.5 mm or at least about 1 mm or at least about 2 mm or at least about 3 mm or at least about 4 mm or at least about 5 mm or at least about 6 mm or at least about 7 mm or at least about 8 mm or at least about 9 mm or even at least about 10 mm. According to yet other embodiments, the thickness of the first mechanical belt material layer 362 may be not greater than about 30 mm, such as, not greater than about 29 mm or not greater than about 28 mm or not greater than about 27 mm or not greater than about 26 mm or not greater than about 25 mm or not greater than about 24 mm or not greater than about 23 mm or not greater than about 22 mm or not greater than about 21 mm or even not greater than about 20 mm. It will be appreciated that the thickness of the first mechanical belt material layer 362 may be within a range between any of the values noted above. It will be further appreciated that the thickness of the first mechanical belt material layer 362 may be any value between any of the values noted above.

According to still other embodiments, the second mechanical belt material layer 364 may include a particular material. For example, the second mechanical belt material layer 364 may include cloth, vulcanized fiber, paper, nonwoven materials, fibrous reinforced thermoplastic backing, polymeric films, substrates containing hooked stems, looped fabrics, metal foils, mesh, foam backings, or laminated multilayer combinations thereof. According to particular embodiments, cloth backings can be untreated, saturated, pre-sized, backsized, porous, or sealed, and they may be woven or stitch bonded. According to still other embodiments, the cloth backings may include fibers or yarns of cotton, polyester, rayon, silk, nylon or blends thereof. According to yet other embodiments, the cloth backings can be provided as laminates with different backing materials described herein. According to other embodiments, paper backings also can be saturated, barrier coated, pre-sized, backsized, untreated, or fiber-reinforced. According to still other embodiments, the paper backings also can be provided as laminates with a different type of backing material. According to yet other embodiments, nonwoven backings include scrims and laminates to different backing materials mentioned herein. According to still other embodiments, the nonwovens may be formed of cellulosic fibers, synthetic fibers or blends thereof. Polymeric backings include polyolefin or polyester films. According to yet other embodiments, the polymeric backings can be provided as blown film, or as laminates of different types of polymeric materials, or laminates of polymeric films with a non-polymeric type of backing material. According to still other embodiments, the backing can also be a stem web used alone or incorporating a nonwoven, or as a laminate with a different type of backing. According to yet other embodiments, the loop fabric backing can be brushed nylon, brushed polyester, polyester stitched loop, and loop material laminated to a different type of backing material. According to still other embodiments, the foam backing may be a natural sponge material or polyurethane foam and the like. According to other embodiments, the foam backing also can be laminated to a different type of backing material. According to still other embodiments, the mesh backings can be made of polymeric or metal open-weave scrims.

According to still other embodiments, the second mechanical belt material layer 364 may have a particular thickness. For example, the thickness of the second mechanical belt material layer 364 may be at least about 0.025 mm, such as, at least about 0.05 mm or at least about 0.075 mm or at least about 0.1 mm or at least about 0.5 mm or at least about 1 mm or at least about 2 mm or at least about 3 mm or at least about 4 mm or at least about 5 mm or at least about 6 mm or at least about 7 mm or at least about 8 mm or at least about 9 mm or even at least about 10 mm. According to yet other embodiments, the thickness of the second mechanical belt material layer 364 may be not greater than about 30 mm, such as, not greater than about 29 mm or not greater than about 28 mm or not greater than about 27 mm or not greater than about 26 mm or not greater than about 25 mm or not greater than about 24 mm or not greater than about 23 mm or not greater than about 22 mm or not greater than about 21 mm or even not greater than about 20 mm. It will be appreciated that the thickness of the second mechanical belt material layer 364 may be within a range between any of the values noted above. It will be further appreciated that the thickness of the second mechanical belt material layer 364 may be any value between any of the values noted above.

According to yet other embodiments, the multilayer mechanical belt 300 may have a particular thickness ratio FML_{T}/SML_{T}, where FML_{T} is the thickness of the first mechanical belt material layer and SML_{T} is the thickness of the second mechanical belt material layer. According to particular embodiments, the multilayer mechanical belt 300 may have a thickness ratio FML_{T}/SML_{T} of at least about 0.0008, such as, at least about 0.001 or at least about 0.005 or at least about 0.01 or at least about 0.05 or even at least about 0.1. It will be appreciated that the thickness ratio FML_{T}/SML_{T} of the multilayer mechanical belt 300 may be within a range between any of the values noted above. It will be further appreciated that the thickness ratio FML_{T}/SML_{T} of the multilayer mechanical belt 300 may be any value between any of the values noted above.

According to yet other embodiments, the first central overlap region adhesive 366 may have include a particular material. For example, the first central overlap region adhesive 366 may include epoxy, urethane, acrylic, silicone, rubber, natural rubber, phenolic resin, amino resin, aminoplast resin, phenol-formaldehyde, urea-formaldehyde, melamine-formaldehyde, styrene isoprene copolymers, styrene butadiene copolymers, acrylated isocyanurate resins, and mixtures thereof. According to still other embodiments, the first central overlap region adhesive 366 may consist of epoxy, urethane, acrylic, silicone, rubber, natural rubber, phenolic resin, amino resin, aminoplast resin, phenol-formaldehyde, urea-formaldehyde, melamine-formaldehyde, styrene isoprene copolymers, styrene butadiene copolymers, acrylated isocyanurate resins, and mixtures thereof. According to still other embodiments, the first central overlap region adhesive 366 may be a layer of epoxy, urethane, acrylic, silicone, rubber, natural rubber, phenolic resin, amino resin, aminoplast resin, phenol-formaldehyde, urea-formaldehyde, melamine-formaldehyde, styrene isoprene copolymers, styrene butadiene copolymers, acrylated isocyanurate resins, and mixtures thereof.

According to still other embodiments, the first central overlap region adhesive 366 may have a particular thickness. For example, the thickness of the first central overlap region adhesive 366 may be at least about 0.025 mm, such as, at least about 0.05 mm or at least about 0.075 mm or at least about 0.1 mm or at least about 0.5 mm or at least about 1 mm or at least about 2 mm or at least about 3 mm or at least about 4 mm or at least about 5 mm or at least about 6 mm or at least about 7 mm or at least about 8 mm or at least about 9 mm or even at least about 10 mm. According to yet other embodiments, the thickness of the first central overlap region adhesive 366 may be not greater than about 30 mm, such as, not greater than about 29 mm or not greater than about 28 mm or not greater than about 27 mm or not greater than about 26 mm or not greater than about 25 mm or not greater than about 24 mm or not greater than about 23 mm or not greater than about 22 mm or not greater than about 21 mm or even not greater than about 20 mm. It will be appreciated that the thickness of the first central overlap region adhesive 366 may be within a range between any of the values noted above. It will be further appreciated that the thickness of the first central overlap region adhesive 366 may be any value between any of the values noted above.

According to still other embodiments, the first tab backing material 322 may include a particular material. For example, the first tab backing material 322 may include cloth, vulcanized fiber, paper, nonwoven materials, fibrous reinforced thermoplastic backing, polymeric films, substrates containing hooked stems, looped fabrics, metal foils, mesh, foam backings, or laminated multilayer combinations thereof. According to particular embodiments, cloth backings can be untreated, saturated, pre-sized, backsized, porous, or sealed, and they may be woven or stitch bonded. According to still other embodiments, the cloth backings may include fibers or yarns of cotton, polyester, rayon, silk, nylon or blends thereof. According to yet other embodiments, the cloth backings can be provided as laminates with different backing materials described herein. According to other embodiments, paper backings also can be saturated, barrier coated, pre-sized, backsized, untreated, or fiber-reinforced. According to still other embodiments, the paper backings also can be provided as laminates with a different type of backing material. According to yet other embodiments, nonwoven backings include scrims and laminates to different backing materials mentioned herein. According to still other embodiments, the nonwovens may be formed of cellulosic fibers, synthetic fibers or blends thereof. Polymeric backings include polyolefin or polyester films. According to yet other embodiments, the polymeric backings can be provided as blown film, or as laminates of different types of polymeric materials, or laminates of polymeric films with a non-polymeric type of backing material. According to still other embodiments, the backing can also be a stem web used alone or incorporating a nonwoven, or as a laminate with a different type of backing. According to yet other embodiments, the loop fabric backing can be brushed nylon, brushed polyester, polyester stitched loop, and loop material laminated to a different type of backing material. According to still other embodiments, the foam backing may be a natural sponge material or polyurethane foam and the like. According to other embodiments, the foam backing also can be laminated to a different type of backing material. According to still other embodiments, the mesh backings can be made of polymeric or metal open-weave scrims.

According to still other embodiments, the first tab backing material 322 may have a particular thickness. For example, the thickness of the first tab backing material 322 may be at least about 0.001 mm, such as, at least about 0.005 mm or at least about 0.01 mm or at least about 0.05 mm or at least about 0.075 mm or at least about 0.1 mm or at least about 0.5 mm or at least about 1 mm or at least about 2 mm or at least about 3 mm or at least about 4 mm or at least about 5 mm or at least about 6 mm or at least about 7 mm or at least about 8 mm or at least about 9 mm or even at least about 10 mm. According to yet other embodiments, the thickness of the first tab backing material 322 may be not greater than about 30 mm, such as, not greater than about 29 mm or not greater than about 28 mm or not greater than about 27 mm or not greater than about 26 mm or not greater than about 25 mm or not greater than about 24 mm or not greater than about 23 mm or not greater than about 22 mm or not greater than about 21 mm or even not greater than about 20 mm. It will be appreciated that the thickness of the first tab backing material 322 may be within a range between any of the values noted above. It will be further appreciated that the thickness of the first tab backing material 322 may be any value between any of the values noted above.

According to still other embodiments, the first tab adhesive material 324 may include a particular material. For example, the first tab adhesive material 324 may include epoxy, urethane, acrylic, silicone, rubber, natural rubber, phenolic resin, amino resin, aminoplast resin, phenol-formaldehyde, urea-formaldehyde, melamine-formaldehyde, styrene isoprene copolymers, styrene butadiene copolymers, acrylated isocyanurate resins, and mixtures thereof. According to still other embodiments, the first tab adhesive material 324 may consist of epoxy, urethane, acrylic, silicone, rubber, natural rubber, phenolic resin, amino resin, aminoplast resin, phenol-formaldehyde, urea-formaldehyde, melamine-formaldehyde, styrene isoprene copolymers, styrene butadiene copolymers, acrylated isocyanurate resins, and mixtures thereof. According to yet other embodiments, the first tab adhesive material 324 may be a layer of epoxy, urethane, acrylic, silicone, rubber, natural rubber, phenolic resin, amino resin, aminoplast resin, phenol-formaldehyde, urea-formaldehyde, melamine-formaldehyde, styrene isoprene copolymers, styrene butadiene copolymers, acrylated isocyanurate resins, and mixtures thereof.

According to still other embodiments, the first tab adhesive material 324 may have a particular thickness. For example, the thickness of the first tab adhesive material 324 may be at least about 0.0125 mm, such as, at least about 0.025 mm or at least about 0.05 mm or at least about 0.075 mm or at least about 0.1 mm or at least about 0.5 mm or at least about 1 mm or at least about 2 mm or at least about 3 mm or at least about 4 mm or at least about 5 mm or at least about 6 mm or at least about 7 mm or at least about 8 mm or at least about 9 mm or even at least about 10 mm. According to yet other embodiments, the thickness of the first tab adhesive material 324 may be not greater than about 30 mm, such as, not greater than about 29 mm or not greater than about 28 mm or not greater than about 27 mm or not greater than about 26 mm or not greater than about 25 mm or not greater than about 24 mm or not greater than about 23 mm or not greater than about 22 mm or not greater than about 21 mm or even not greater than about 20 mm. It will be appreciated that the thickness of the first tab adhesive material 324 may be within a range between any of the values noted above. It will be further appreciated that the thickness of the first tab adhesive material 324 may be any value between any of the values noted above.

According to still other embodiments, the second tab backing material 342 may include a particular material. For example, the second tab backing material 342 may include cloth, vulcanized fiber, paper, nonwoven materials, fibrous reinforced thermoplastic backing, polymeric films, substrates containing hooked stems, looped fabrics, metal foils, mesh, foam backings, or laminated multilayer combinations thereof. According to particular embodiments, cloth backings can be untreated, saturated, pre-sized, backsized, porous, or sealed, and they may be woven or stitch bonded. According to still other embodiments, the cloth backings may include fibers or yarns of cotton, polyester, rayon, silk, nylon or blends thereof. According to yet other embodiments, the cloth backings can be provided as laminates with different backing materials described herein. According to other embodiments, paper backings also can be saturated, barrier coated, pre-sized, backsized, untreated, or fiber-reinforced. According to still other embodiments, the paper backings also can be provided as laminates with a different type of backing material. According to yet other embodiments, nonwoven backings include scrims and laminates to different backing materials mentioned herein. According to still other embodiments, the nonwovens may be formed of cellulosic fibers, synthetic fibers or blends thereof. Polymeric backings include polyolefin or polyester films. According to yet other embodiments, the polymeric backings can be provided as blown film, or as laminates of different types of polymeric materials, or laminates of polymeric films with a non-polymeric type of backing material. According to still other embodiments, the backing can also be a stem web used alone or incorporating a nonwoven, or as a laminate with a different type of backing. According to yet other embodiments, the loop fabric backing can be brushed nylon, brushed polyester, polyester stitched loop, and loop material laminated to a different type of backing material. According to still other embodiments, the foam backing may be a natural sponge material or polyurethane foam and the like. According to other embodiments, the foam backing also can be laminated to a different type of backing material. According to still other embodiments, the mesh backings can be made of polymeric or metal open-weave scrims.

According to still other embodiments, the second tab backing material 342 may have a particular thickness. For example, the thickness of the second tab backing material 342 may be at least about 0.001 mm, such as, at least about 0.005 mm or at least about 0.01 mm or at least about 0.05 mm or at least about 0.075 mm or at least about 0.1 mm or at least about 0.5 mm or at least about 1 mm or at least about 2 mm or at least about 3 mm or at least about 4 mm or at least about 5 mm or at least about 6 mm or at least about 7 mm or at least about 8 mm or at least about 9 mm or even at least about 10 mm. According to yet other embodiments, the thickness of the second tab backing material 342 may be not greater than about 30 mm, such as, not greater than about 29 mm or not greater than about 28 mm or not greater than about 27 mm or not greater than about 26 mm or not greater than about 25 mm or not greater than about 24 mm or not greater than about 23 mm or not greater than about 22 mm or not greater than about 21 mm or even not greater than about 20 mm. It will be appreciated that the thickness of the second tab backing material 342 may be within a range between any of the values noted above. It will be further appreciated that the thickness of the second tab backing material 342 may be any value between any of the values noted above.

According to still other embodiments, the second tab adhesive material 344 may include a particular material. For example, the second tab adhesive material 344 may include epoxy, urethane, acrylic, silicone, rubber, natural rubber, phenolic resin, amino resin, aminoplast resin, phenol-formaldehyde, urea-formaldehyde, melamine-formaldehyde, styrene isoprene copolymers, styrene butadiene copolymers, acrylated isocyanurate resins, and mixtures thereof. According to still other embodiments, the second tab adhesive material 344 may consist of epoxy, urethane, acrylic, silicone, rubber, natural rubber, phenolic resin, amino resin, aminoplast resin, phenol-formaldehyde, urea-formaldehyde, melamine-formaldehyde, styrene isoprene copolymers, styrene butadiene copolymers, acrylated isocyanurate resins, and mixtures thereof. According to yet other embodiments, the second tab adhesive material 144 may be a layer of epoxy, urethane, acrylic, silicone, rubber, natural rubber, phenolic resin, amino resin, aminoplast resin, phenol-formaldehyde, urea-formaldehyde, melamine-formaldehyde, styrene isoprene copolymers, styrene butadiene copolymers, acrylated isocyanurate resins, and mixtures thereof.

According to still other embodiments, the second tab adhesive material 344 may have a particular thickness. For example, the thickness of the second tab adhesive material 344 may be at least about 0.0125 mm, such as, at least about 0.025 mm or at least about 0.05 mm or at least about 0.075 mm or at least about 0.1 mm or at least about 0.5 mm or at least about 1 mm or at least about 2 mm or at least about 3 mm or at least about 4 mm or at least about 5 mm or at least about 6 mm or at least about 7 mm or at least about 8 mm or at least about 9 mm or even at least about 10 mm. According to yet other embodiments, the thickness of the first central overlap region adhesive 366 may be not greater than about 30 mm, such as, not greater than about 29 mm or not greater than about 28 mm or not greater than about 27 mm or not greater than about 26 mm or not greater than about 25 mm or not greater than about 24 mm or not greater than about 23 mm or not greater than about 22 mm or not greater than about 21 mm or even not greater than about 20 mm. It will be appreciated that the thickness of the second tab adhesive material 344 may be within a range between any of the values noted above. It will be further appreciated that the thickness of the second tab adhesive material 344 may be any value between any of the values noted above.

According to still other embodiments, the spliced joint region 310 may have a particular breaking strength increase rating, where the break strength increase rating is defined as the percent increase in break strength of the spliced joint region 310 formed from the first angled step-joint tab, and the second angled step-joint tab as compared to the break strength of a spliced joint region having two non-angled step-joint tabs and where break strength is measured according to ASTM D1002. For example, the spliced joint region 310 may have a break strength increase rating of at least about 10%, such as, at least about 15% or at least about 20% or at least about 25% or at least about 30% or at least about 35% or at least about 40% or at least about 45% or even at least about 50%. It will be appreciated that the break strength increase rating of the spliced joint region 310 may be within a range between any of the values noted above. It will be further appreciated that the break strength increase rating of the spliced joint region 310 may be any value between any of the values noted above.

According to still other embodiments, the spliced joint region 310 may have a particular breaking strength as measured according to ASTM D1002. For example, the spliced joint region 310 may have a break strength of at least about 360 N, such as, at least about 370 N or at least about 380 N or at least about 390 N or at least about 300 N or at least about 310 N or at least about 320 N or at least about 430 N or at least about 340 N or at least about 450 N or even at least about 500 N. According to yet other embodiments, the spliced joint region 310 may have a break strength of not greater than about 1,000,000 N, such as, not greater than about 100,000 N or even not greater than about 10,000 N. It will be appreciated that the break strength of the spliced joint region 310 may be within a range between any of the values noted above. It will be further appreciated that the break strength of the spliced joint region 310 may be any value between any of the values noted above.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

### Embodiment 1

An unassembled multilayer mechanical belt comprising a first angled step-joint tab, a second angled step-joint tab, and a central overlap region between the first angled step-joint tab and the second angled step-joint tab, wherein the central overlap region comprises a first mechanical belt material layer overlying and adhered to a second mechanical belt material layer, wherein the first angled step-joint tab comprises a first tab backing material and a first tab adhesive material; wherein the second angled step-joint tab comprises a second tab backing material and a second tab adhesive material; and wherein the first angled step-joint tab is configured to overlap with and adhere to the second angled step-joint tab to create a spliced joint region of an assembled multilayer mechanical belt.

### Embodiment 2

A multilayer mechanical belt comprising spliced joint region and a central overlap region, wherein the central overlap region comprises a first mechanical belt material layer overlying and adhered to a second mechanical belt material layer, wherein the spliced joint region comprises a first angled step-joint tab extending from the first mechanical belt material layer and a second angled-step-joint tab extending from the second mechanical belt material layer, wherein the first angled step-joint tab comprises a first tab backing material and a first tab adhesive material; wherein the second angled step-joint tab comprises a second tab backing material and a second tab adhesive material; and wherein the first angled step-joint tab overlaps with and adheres to the second angled step-joint tab.

### Embodiment 3

The unassembled multilayer mechanical belt or multilayer mechanical belt of any one of embodiments 1 and 2, wherein the spliced joint region comprises a breaking strength increase rating of at least about 10%, where the breaking strength increase rating is defined as the percent increase in break strength of the spliced joint region formed from the first angled step-joint tab, and the second angled step-joint tab as compared to the break strength of a spliced joint region having two non-angled step-joint tabs.

### Embodiment 4

The unassembled multilayer mechanical belt or multilayer mechanical belt of any one of embodiments 1 and 2, wherein the spliced joint region comprises a breaking strength of at least about 360 N or at least about 370 N or at least about 380 N or at least about 390 N or at least about 400 N or at least about 410 N or at least about 420 N or at least about 430 N or at least about 440 N or at least about 450 N or at least about 500 N.

### Embodiment 5

The unassembled multilayer mechanical belt or multilayer mechanical belt of any one of embodiments 1 and 2, wherein the spliced joint region comprises a breaking strength of not greater than about 10,000 N.

### Embodiment 6

The unassembled multilayer mechanical belt or multilayer mechanical belt of any one of embodiments 1 and 2, wherein the first angled step-joint tab comprises a tip angle of not greater than 89° or not greater than about 85° or not greater than about 80° or not greater than about 75° or not greater than about 70° or not greater than about 65° or not greater than about 60° or not greater than about 50° or not greater than about 45° or not greater than about 40° or not greater than about 35° or not greater than about 30° or not greater than about 25° or not greater than about 20° or not greater than about 15°.

### Embodiment 7

The unassembled multilayer mechanical belt or multilayer mechanical belt of any one of embodiments 1 and 2, wherein the first angled step-joint tab comprises a tip angle of at least about 1° or at least about 5° or at least about 10° or at least about 15° or at least about 20° or at least about 25° or at least about 30° or at least about 35° or at least about 40° or at least about 45° or at least about 50° or at least about 55° or at least about 60° or at least about 65° or at least about 70° or at least about 75°.

### Embodiment 8

The unassembled multilayer mechanical belt or multilayer mechanical belt of any one of embodiments 1 and 2, wherein the second angled step-joint tab comprises a tip angle of not greater than 89° or not greater than about 85° or not greater than about 80° or not greater than about 75° or not greater than about 70° or not greater than about 65° or not greater than about 60° or not greater than about 50° or not greater than about 45° or not greater than about 40° or not greater than about 35° or not greater than about 30° or not greater than about 25° or not greater than about 20° or not greater than about 15°.

### Embodiment 9

The unassembled multilayer mechanical belt or multilayer mechanical belt of any one of embodiments 1 and 2, wherein the second angled step-joint tab comprises a tip angle of at least about 1° or at least about 5° or at least about 10° or at least about 15° or at least about 20° or at least about 25° or at least about 30° or at least about 35° or at least about 40° or at least about 45° or at least about 50° or at least about 55° or at least about 60° or at least about 65° or at least about 70° or at least about 75°.

### Embodiment 10

The unassembled multilayer mechanical belt or multilayer mechanical belt of any one of embodiments 1 and 2, wherein the first angled step-joint tab and the second angle tip joint tab terminate with a tip on the same side of the multilayer mechanical belt when assembled.

### Embodiment 11

The unassembled multilayer mechanical belt or multilayer mechanical belt of any one of embodiments 1 and 2, wherein the first angled step-joint and the second angle tip joint terminate with a tip on different sides of the multilayer mechanical belt when assembled.

### Embodiment 12

The unassembled multilayer mechanical belt or multilayer mechanical belt of any one of embodiments 1 and 2, wherein the first angled step-joint tab comprises a tab length of at least about 30 mm or at least about 35 mm or at least about 40 mm or at least about 45 mm or at least about 50 mm or at least about 55 mm or at least about 60 mm or at least about 70 mm or at least about 75 mm or at least about 80 mm or at least about 85 mm or at least about 90 mm or at least about 95 mm or at least about 100 mm or at least about 105 mm or at least about 110 mm or at least about 120 mm or at least about 130 mm or at least about 140 mm or at least about 145 mm or at least about 150 mm.

### Embodiment 13

The unassembled multilayer mechanical belt or multilayer mechanical belt of any one of embodiments 1 and 2, wherein the first angled step-joint tab comprises a tab length of not greater than about 1000 meters or not greater than about 750 meters or not greater than about 500 meters or not greater than about 250 meters or not greater than about 100 meters or not greater than about 1 meter or not greater than about 750 mm or not greater than about 500 mm or not greater than about 250 mm or not greater than about 200 mm or not greater than about 195 mm or not greater than about 190 mm or not greater than about 185 mm or not greater than about 180 mm or not greater than about 175 mm or not greater than about 170 mm or not greater than about 165 mm or not greater than about 160 mm or not greater than about 155 mm or not greater than about 150 mm.

### Embodiment 14

The unassembled multilayer mechanical belt or multilayer mechanical belt of any one of embodiments 1 and 2, wherein the second angled step-joint tab comprises a tab length of at least about 30 mm or at least about 35 mm or at least about 40 mm or at least about 45 mm or at least about 50 mm or at least about 55 mm or at least about 60 mm or at least about 70 mm or at least about 75 mm or at least about 80 mm or at least about 85 mm or at least about 90 mm or at least about 95 mm or at least about 100 mm or at least about 105 mm or at least about 110 mm or at least about 120 mm or at least about 130 mm or at least about 140 mm or at least about 145 mm or at least about 150 mm.

### Embodiment 15

The unassembled multilayer mechanical belt or multilayer mechanical belt of any one of embodiments 1 and 2, wherein the second angled step-joint tab comprises a tab length of not greater than about 1000 meters or not greater than about 750 meters or not greater than about 500 meters or not greater than about 250 meters or not greater than about 100 meters or not greater than about 1 meter or not greater than about 750 mm or not greater than about 500 mm or not greater than about 250 mm or not greater than about 200 mm or not greater than about 195 mm or not greater than about 190 mm or not greater than about 185 mm or not greater than about 180 mm or not greater than about 175 mm or not greater than about 170 mm or not greater than about 165 mm or not greater than about 160 mm or not greater than about 155 mm or not greater than about 150 mm.

### Embodiment 16

The unassembled multilayer mechanical belt or multilayer mechanical belt of any one of embodiments 1 and 2, wherein the first angled step-joint tab comprises a tab thickness of at least about 25 micrometers.

### Embodiment 17

The unassembled multilayer mechanical belt or multilayer mechanical belt of any one of embodiments 1 and 2, wherein the first angled step-joint tab comprises a tab thickness of not greater than about 30 mm.

### Embodiment 18

The unassembled multilayer mechanical belt or multilayer mechanical belt of any one of embodiments 1 and 2, wherein the second angled step-joint tab comprises a tab thickness of at least about 25 micrometers.

### Embodiment 19

The unassembled multilayer mechanical belt or multilayer mechanical belt of any one of embodiments 1 and 2, wherein the second angled step-joint tab comprises a tab thickness of not greater than about 30 mm.

### Embodiment 20

The unassembled multilayer mechanical belt or multilayer mechanical belt of any one of embodiments 1 and 2, wherein the multilayer mechanical belt comprises a region ratio SJ_{L}/OL_{L} of at least about 1/10,000, where SJ_{L} is the length of the spliced joint region and OL_{L} is the length of the overlap region.

### Embodiment 21

The unassembled multilayer mechanical belt or multilayer mechanical belt of any one of embodiments 1 and 2, wherein the multilayer mechanical belt comprises a region ratio SJ_{L}/OL_{L} of not greater than about 1, where SJ_{L} is the length of the spliced joint region and OL_{L} is the length of the overlap region.

### Embodiment 22

The unassembled multilayer mechanical belt or multilayer mechanical belt of any one of embodiments 1 and 2, wherein the multilayer mechanical belt comprises a region ratio FT_{L}/OL_{L} of at least about 1/10,000, where FT_{L} is the length of the first angled step-joint tab and OL_{L} is the length of the overlap region.

### Embodiment 23

The unassembled multilayer mechanical belt or multilayer mechanical belt of any one of embodiments 1 and 2, wherein the multilayer mechanical belt comprises a region ratio FT_{L}/OL_{L} of not greater than about 1, where FT_{L} is the length of the first angled step-joint tab and OL_{L} is the length of the overlap region.

### Embodiment 24

The unassembled multilayer mechanical belt or multilayer mechanical belt of any one of embodiments 1 and 2, wherein the multilayer mechanical belt comprises a region ratio ST_{L}/OL_{L} of at least about 1/10000, where ST_{L} is the length of the second angled step-joint tab and OL_{L} is the length of the overlap region.

### Embodiment 25

The unassembled multilayer mechanical belt or multilayer mechanical belt of any one of embodiments 1 and 2, wherein the multilayer mechanical belt comprises a region ratio ST_{L}/OL_{L} of not greater than about 1, where ST_{L} is the length of the second angled step-joint tab and OL_{L} is the length of the overlap region.

### Embodiment 26

The unassembled multilayer mechanical belt or multilayer mechanical belt of any one of embodiments 1 and 2, wherein the overlap region comprises a length of at least about 1 mm.

### Embodiment 27

The unassembled multilayer mechanical belt or multilayer mechanical belt of any one of embodiments 1 and 2, wherein the overlap region comprises a length of not greater than about 2000 meters.

### Embodiment 28

The unassembled multilayer mechanical belt or multilayer mechanical belt of any one of embodiments 1 and 2, wherein the spliced joint region comprises a length of at least about 30 mm or at least about 35 mm or at least about 40 mm or at least about 45 mm or at least about 50 mm or at least about 55 mm or at least about 60 mm or at least about 70 mm or at least about 75 mm or at least about 80 mm or at least about 85 mm or at least about 90 mm or at least about 95 mm or at least about 100 mm or at least about 105 mm or at least about 110 mm or at least about 120 mm or at least about 130 mm or at least about 140 mm or at least about 145 mm or at least about 150 mm.

### Embodiment 29

The unassembled multilayer mechanical belt or multilayer mechanical belt of any one of embodiments 1 and 2, wherein the spliced joint region comprises a length of not greater than about 1000 meters or not greater than about 750 meters or not greater than about 500 meters or not greater than about 250 meters or not greater than about 100 meters or not greater than about 1 meter or not greater than about 750 mm or not greater than about 500 mm or not greater than about 250 mm or not greater than about 200 mm or not greater than about 195 mm or not greater than about 190 mm or not greater than about 185 mm or not greater than about 180 mm or not greater than about 175 mm or not greater than about 170 mm or not greater than about 165 mm or not greater than about 160 mm or not greater than about 155 mm or not greater than about 150 mm.

### Embodiment 30

The unassembled multilayer mechanical belt or multilayer mechanical belt of any one of embodiments 1 and 2, wherein the multilayer mechanical belt comprises a thickness of at least about 50 μm.

### Embodiment 31

The unassembled multilayer mechanical belt or multilayer mechanical belt of any one of embodiments 1 and 2, wherein the multilayer mechanical belt comprises a thickness of not greater than about 60 mm.

### Embodiment 32

The unassembled multilayer mechanical belt or multilayer mechanical belt of any one of embodiments 1 and 2, wherein the multilayer mechanical belt comprises a unassembled length of at least about 3 mm.

### Embodiment 33

The unassembled multilayer mechanical belt or multilayer mechanical belt of any one of embodiments 1 and 2, wherein the multilayer mechanical belt comprises an unassembled length of not greater than about 2000 meters.

### Embodiment 34

The unassembled multilayer mechanical belt or multilayer mechanical belt of any one of embodiments 1 and 2, wherein the multilayer mechanical belt comprises a circular length of at least about 3 mm.

### Embodiment 35

The unassembled multilayer mechanical belt or multilayer mechanical belt of any one of embodiments 1 and 2, wherein the multilayer mechanical belt comprises a circular length of not greater than about 2000 meters.

### Embodiment 36

The unassembled multilayer mechanical belt or multilayer mechanical belt of any one of embodiments 1 and 2, wherein the multilayer mechanical belt comprises a width of at least about 1 mm.

### Embodiment 37

The unassembled multilayer mechanical belt or multilayer mechanical belt of any one of embodiments 1 and 2, wherein the multilayer mechanical belt comprises a width of not greater than about 2 meters.

### Embodiment 38

The unassembled multilayer mechanical belt or multilayer mechanical belt of any one of embodiments 1 and 2, wherein the first mechanical belt material layer comprises cloth, vulcanized fiber, paper, nonwoven materials, fibrous reinforced thermoplastic backing, polymeric films, substrates containing hooked stems, looped fabrics, metal foils, mesh, foam backings, and laminated multilayer combinations thereof.

### Embodiment 39

The unassembled multilayer mechanical belt or multilayer mechanical belt of any one of embodiments 1 and 2, wherein the first mechanical belt material layer comprises a thickness of at least about 25 μm.

### Embodiment 40

The unassembled multilayer mechanical belt or multilayer mechanical belt of any one of embodiments 1 and 2, wherein the first material mechanical belt layer comprises a thickness of not greater than about 30 mm.

### Embodiment 41

The unassembled multilayer mechanical belt or multilayer mechanical belt of any one of embodiments 1 and 2, wherein the second mechanical belt material layer comprises cloth, vulcanized fiber, paper, nonwoven materials, fibrous reinforced thermoplastic backing, polymeric films, substrates containing hooked stems, looped fabrics, metal foils, mesh, foam backings, and laminated multilayer combinations thereof.

### Embodiment 42

The unassembled multilayer mechanical belt or multilayer mechanical belt of any one of embodiments 1 and 2, wherein the second mechanical belt material layer comprises a thickness of at least about 25 μm.

### Embodiment 43

The unassembled multilayer mechanical belt or multilayer mechanical belt of any one of embodiments 1 and 2, wherein the second mechanical belt material layer comprises a thickness of not greater than about 30 mm.

### Embodiment 44

The unassembled multilayer mechanical belt or multilayer mechanical belt of any one of embodiments 1 and 2, wherein the multilayer mechanical belt comprises a thickness ratio FML_{T}/SML_{T} of at least about 0.000833, where FML_{T} is the thickness of the first mechanical belt material layer and SML_{T} is the thickness of the second mechanical belt material layer.

### Embodiment 45

The unassembled multilayer mechanical belt or multilayer mechanical belt of any one of embodiments 1 and 2, wherein the multilayer mechanical belt further comprises an overlap region adhesive between the first mechanical belt material layer and the second mechanical belt material layer.

### Embodiment 46

The unassembled multilayer mechanical belt or multilayer mechanical belt of embodiment 45, wherein the overlap adhesive comprises epoxy, urethane, acrylic, silicone, rubber, natural rubber, phenolic resin, amino resin, aminoplast resin, phenol- formaldehyde, urea-formaldehyde, melamine-formaldehyde, styrene isoprene copolymers, styrene butadiene copolymers, acrylated isocyanurate resins, and mixtures thereof.

### Embodiment 47

The unassembled multilayer mechanical belt or multilayer mechanical belt of embodiment 45, wherein the overlap adhesive comprises a thickness of at least about 25 μm.

### Embodiment 48

The unassembled multilayer mechanical belt or multilayer mechanical belt of embodiment 45, wherein the overlap adhesive comprises a thickness of not greater than about 30 mm.

### Embodiment 49

The unassembled multilayer mechanical belt or multilayer mechanical belt of any one of embodiments 1 and 2, wherein the first tab backing material comprises cloth, vulcanized fiber, paper, nonwoven materials, fibrous reinforced thermoplastic backing, polymeric films, substrates containing hooked stems, looped fabrics, metal foils, mesh, foam backings, and laminated multilayer combinations thereof.

### Embodiment 50

The unassembled multilayer mechanical belt or multilayer mechanical belt of any one of embodiments 1 and 2, wherein the first tab backing material comprises a thickness of at least about 1 μm.

### Embodiment 51

The unassembled multilayer mechanical belt or multilayer mechanical belt of any one of embodiments 1 and 2, wherein the first tab backing material comprises a thickness of not greater than about 30 mm.

### Embodiment 52

The unassembled multilayer mechanical belt or multilayer mechanical belt of any one of embodiments 1 and 2, wherein the first tab adhesive material comprises epoxy, urethane, acrylic, silicone, rubber, natural rubber, phenolic resin, amino resin, aminoplast resin, phenol-formaldehyde, urea-formaldehyde, melamine-formaldehyde, styrene isoprene copolymers, styrene butadiene copolymers, acrylated isocyanurate resins, and mixtures thereof.

### Embodiment 53

The unassembled multilayer mechanical belt or multilayer mechanical belt of any one of embodiments 1 and 2, wherein the first tab adhesive material comprises a thickness of at least about 12.5 μm.

### Embodiment 54

The unassembled multilayer mechanical belt or multilayer mechanical belt of any one of embodiments 1 and 2, wherein the first tab adhesive material comprises a thickness of not greater than about 30 mm.

### Embodiment 55

The unassembled multilayer mechanical belt or multilayer mechanical belt of any one of embodiments 1 and 2, wherein the second tab backing material comprises cloth, vulcanized fiber, paper, nonwoven materials, fibrous reinforced thermoplastic backing, polymeric films, substrates containing hooked stems, looped fabrics, metal foils, mesh, foam backings, and laminated multilayer combinations thereof.

### Embodiment 56

The unassembled multilayer mechanical belt or multilayer mechanical belt of any one of embodiments 1 and 2, wherein the second tab backing material comprises a thickness of at least about 1 μm.

### Embodiment 57

The unassembled multilayer mechanical belt or multilayer mechanical belt of any one of embodiments 1 and 2, wherein the second tab backing material comprises a thickness of not greater than about 30 mm.

### Embodiment 58

The unassembled multilayer mechanical belt or multilayer mechanical belt of any one of embodiments 1 and 2, wherein the second tab adhesive material comprises epoxy, urethane, acrylic, silicone, rubber, natural rubber, phenolic resin, amino resin, aminoplast resin, phenol-formaldehyde, urea-formaldehyde, melamine-formaldehyde, styrene isoprene copolymers, styrene butadiene copolymers, acrylated isocyanurate resins, and mixtures thereof.

### Embodiment 59

The unassembled multilayer mechanical belt or multilayer mechanical belt of any one of embodiments 1 and 2, wherein the second tab adhesive material comprises a thickness of at least about 12.5 μm.

### Embodiment 60

The unassembled multilayer mechanical belt or multilayer mechanical belt of any one of embodiments 1 and 2, wherein the second tab adhesive material comprises a thickness of not greater than about 5 mm.

### EXAMPLES

The concepts described herein will be further described in the following Examples, which do not limit the scope of the invention described in the claims.

### Example 1

Three sample multilayer mechanical belts S1, S2 and S3 were formed according to embodiments described herein. In particular, sample multilayer mechanical belts S1, S2 and S3 were formed according to embodiments described herein with a first angled step-joint tab and a second angled stop-joint tab having various tip angles TA₁ and TA₂. A comparative sample multilayer mechanical belt CS1 was formed with convention step-joint tabs having no angled tips. The first tab backing material for each sample multilayer mechanical belts S1, S2 and S3 and comparative sample CS1 was extruded PTFE. The first tab adhesive material for each sample multilayer mechanical belts S1, S2 and S3 and comparative sample CS1 was as silicone adhesive. The second tab backing material for each sample multilayer mechanical belts S1, S2 and S3 and comparative sample CS1 was skived PTFE. The second tab adhesive material for each sample multilayer mechanical belts S1, S2 and S3 and comparative sample CS1 was as silicone adhesive. Each sample multilayer mechanical belt S1, S2 and S3 and the comparative sample multilayer mechanical belt CS1 were tested to determine the break strength of the spliced joint region. The break strength was measured according to ASTM D1002. Table 1 below summarizes the characteristics and break strength performance of the sample multilayer mechanical belts S1, S2 and S3 and comparative sample CS1.

TABLE 1-
Charateristics and Performance of Sample and
Comparative Sample Multilayer Mechanical Belts

| | Tip | Tip | Break |
|---|---|---|---|
| Sample | Angle TA₁ | Angle TA₂ | Strength |
| S1 | 75° | 75° | 420N |
| S2 | 60° | 60° | 420N |
| S3 | 45° | 45° | 440N |
| CS1 | None (90° C.) | None (90° C.) | 350N |

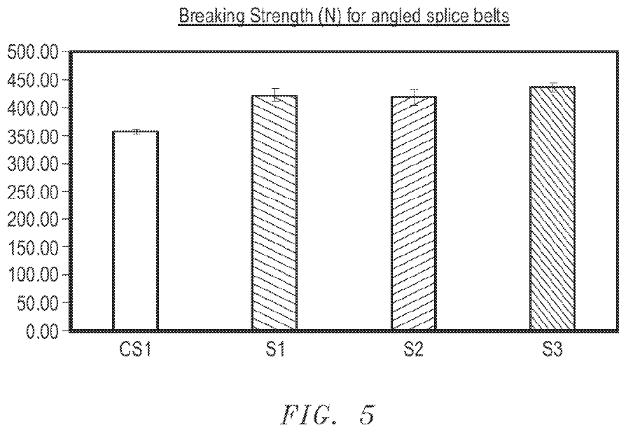

FIG. 5 includes a bar graph demonstrating the break strength performance of sample multilayer mechanical belts S1, S2 and S3 and comparative sample CS1.

### Example 2

Three sample multilayer mechanical belts S4, S5 and S6 were formed according to embodiments described herein. In particular, sample multilayer mechanical belts S4, S5 and S6 were formed according to embodiments described herein with different tab lengths TL₁ and TL₂. The first tab backing material for each sample multilayer mechanical belts S4, S5 and S6 was extruded PTFE. The first tab adhesive material for each sample multilayer mechanical belts S4, S5 and S6 was as silicone adhesive. The second tab backing material for each sample multilayer mechanical belts S4, S5 and S6 was skived PTFE. The second tab adhesive material for each sample multilayer mechanical belts S4, S5 and S6 was as silicone adhesive. Each sample multilayer mechanical belt S4, S5 and S6 were tested to determine the break strength of the spliced joint region. The break strength was measured according to ASTM D1002. Table 2 below summarizes the characteristics and break strength performance of the sample multilayer mechanical belts S4, S5 and S6.

TABLE 2
Charateristics and Performance
of Sample Multilayer Mechanical Belts

| | Tip | | Tab | Tab | |
|---|---|---|---|---|---|
| | Angle | Angle | Length | Length | Break |
| Sample | TA₁ | TA₂ | TL₁ | TL2 | Strength |
| S4 | 45° | 45° | 50 mm | 50 mm | 420N |
| S5 | 45° | 45° | 100 mm | 100 mm | 640N |
| S6 | 45° | 45° | 150 mm | 150 mm | 790N |

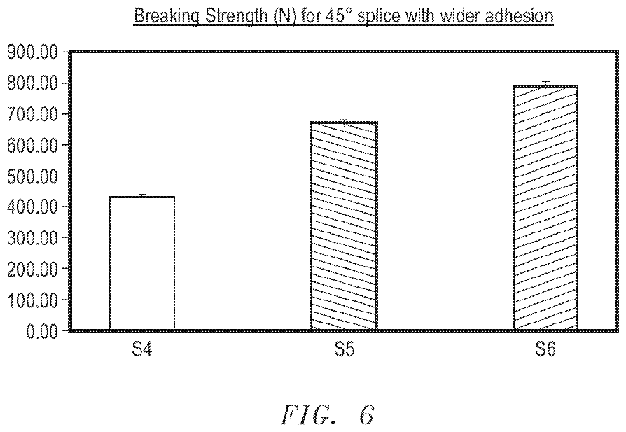

FIG. 6 includes a bar graph demonstrating the break strength performance of sample multilayer mechanical belts S4, S5 and S6.

### Example 3

Six sample multilayer mechanical belts S7, S8, S9, S10, S11 and S12 were formed according to embodiments described herein. In particular, sample multilayer mechanical belts S7-S12 were formed according to embodiments described herein with a first angled step-joint tab and a second angled stop-joint tab having the same tip angles TA₁ and TA₂ and the same Tab Lengths TL₁ and TL₂. However, each sample multilayer mechanical belts S7-S12 were formed according to embodiments described herein different combinations of tab backing materials and tab adhesives. For purposes of comparison, six comparative sample multilayer mechanical belts CS2, CS3, CS4, CS5, CS6 and CS7 were formed having no angled tips, but having corresponding combinations of tab backing materials and tab adhesives to those of S7-S12. Table 3 below summarizes the characteristics and combinations of tab backing materials for each sample and comparative sample mechanical belt.

TABLE 3
Charateristics and Layer Combinations of Sample and C
omparative Sample Multilayer Mechanical Belts

| | | | | | First | | Second | |
|---|---|---|---|---|---|---|---|---|
| | Tip | Tip | Tab | Tab | Tab | First | Tab | Second |
| | Angle | Angle | Length | Length | Backing | Tab | Backing | Tab |
| Sample | TA₁ | TA₂ | TL₁ | TL₂ | Material | Adhesive | Material | Adhesive |
| CS2 | None | None | 50 mm | 50 mm | Aluminum | Silicone | Aluminum | Silicone |
| | | | | | Laminated | | Laminated | |
| | | | | | with FEP | | with FEP | |
| S7 | 45° | 45° | 50 mm | 50 mm | Aluminum | Silicone | Aluminum | Silicone |
| | | | | | Laminated | | Laminated | |
| | | | | | with FEP | | with FEP | |
| CS3 | None | None | 50 mm | 50 mm | Polyimide | Silicone | Polyimide | Silicone |
| S8 | 45° | 45° | 50 mm | 50 mm | Polyimide | Silicone | Polyimide | Silicone |
| CS4 | None | None | 50 mm | 50 mm | PTFE | Silicone | PTFE | Silicone |
| | | | | | Coated | | Coated | |
| | | | | | Glass | | Glass | |
| S9 | 45° | 45° | 50 mm | 50 mm | PTFE | Silicone | PTFE | Silicone |
| | | | | | Coated | | Coated | |
| | | | | | Glass | | Glass | |
| CS5 | None | None | 50 mm | 50 mm | Aluminum | Silicone | PTFE | Silicone |
| | | | | | Laminated | | Coated | |
| | | | | | with FEP | | Glass | |
| S10 | 45° | 45° | 50 mm | 50 mm | Aluminum | Silicone | PTFE | Silicone |
| | | | | | Laminated | | Coated | |
| | | | | | with FEP | | Glass | |
| CS6 | None | None | 50 mm | 50 mm | Aluminum | Silicone | Polyimide | Silicone |
| | | | | | Laminated | | | |
| | | | | | with FEP | | | |
| S11 | 45° | 45° | 50 mm | 50 mm | Aluminum | Silicone | Polyimide | Silicone |
| | | | | | Laminated | | | |
| | | | | | with FEP | | | |
| CS7 | None | None | 50 mm | 50 mm | Polyimide | Silicone | PTFE | Silicone |
| | | | | | | | Coated | |
| | | | | | | | Glass | |
| S12 | 45° | 45° | 50 mm | 50 mm | Polyimide | Silicone | PTFE | Silicone |
| | | | | | | | Coated | |
| | | | | | | | Glass | |

Each sample multilayer mechanical belts S6-S12 and each comparative sample multilayer mechanical belts CS2-CS7 were tested to determine the break strength of the spliced joint region. The break strength was measured according to ASTM D1002. Table 4 below summarizes the break strength performance of the sample multilayer mechanical belts S6-S12 and the comparative sample multilayer mechanical belts CS2-CS7.

TABLE 4
Performance of Sample and Comparative
Sample Multilayer Mechanical Belts

| | | Break |
|---|---|---|
| | | Strength |
| | Break | Increase |
| Sample | Strength | Rating |
| CS2 | 305N | — |
| S7 | 490N | 60.65% |
| CS3 | 190N | — |
| S8 | 305N | 60.52% |
| CS4 | 330N | — |
| S9 | 530N | 60.61% |
| CS5 | 290N | — |
| S10 | 480N | 65.52% |
| CS6 | 160N | — |
| S11 | 290N | 81.25% |
| CS7 | 285N | — |
| S12 | 425N | 49.12% |

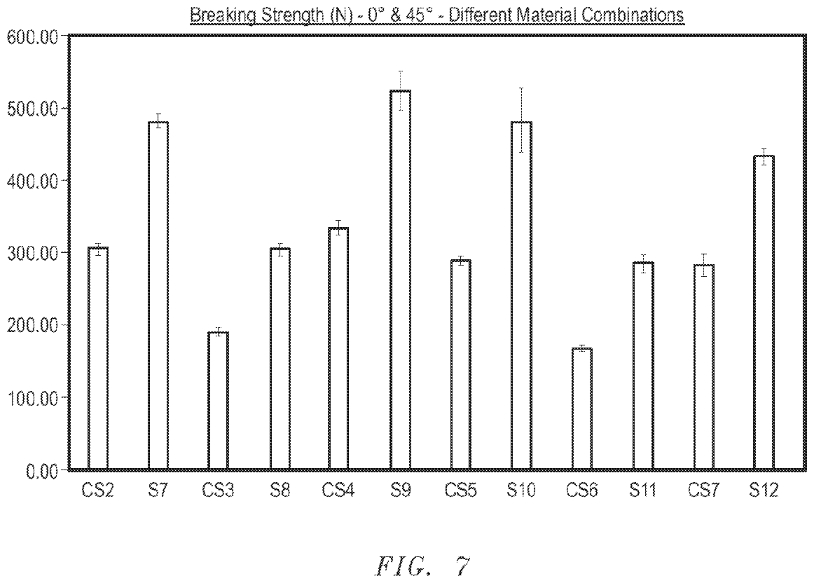

FIG. 7 includes a bar graph demonstrating the break strength performance of sample multilayer mechanical belts S6-S12 and comparative sample multilayer mechanical belts CS2-CS7.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. An unassembled multilayer mechanical belt comprising a first angled step-joint tab, a second angled step-joint tab, and a central overlap region between the first angled step-joint tab and the second angled step-joint tab,
wherein the central overlap region comprises a first mechanical belt material layer overlying and adhered to a second mechanical belt material layer,
wherein the first angled step-joint tab comprises a first tab backing material and a first tab adhesive material;
wherein the second angled step-joint tab comprises a second tab backing material and a second tab adhesive material; and
wherein the first angled step-joint tab is configured to overlap with and adhere to the second angled step-joint tab to create a spliced joint region of an assembled multilayer mechanical belt.

2. The unassembled multilayer mechanical belt of claim 1, wherein the spliced joint region comprises a breaking strength increase rating of at least about 10%, where the breaking strength increase rating is defined as the percent increase in break strength of the spliced joint region formed from the first angled step-joint tab, and the second angled step-joint tab as compared to the break strength of a spliced joint region having two non-angled step-joint tabs.

3. The unassembled multilayer mechanical belt of claim 1, wherein the spliced joint region comprises a breaking strength of at least about 360 N.

4. The unassembled multilayer mechanical belt of claim 1, wherein the spliced joint region comprises a breaking strength of not greater than about 10,000 N.

5. The unassembled multilayer mechanical belt of claim 1, wherein the first angled step-joint tab comprises a tip angle of not greater than 89°.

6. The unassembled multilayer mechanical belt of claim 1, wherein the first angled step-joint tab comprises a tip angle of at least about 1°.

7. The unassembled multilayer mechanical belt of claim 1, wherein the second angled step-joint tab comprises a tip angle of not greater than 89°.

8. The unassembled multilayer mechanical belt of claim 1, wherein the second angled step-joint tab comprises a tip angle of at least about 1°.

9. The unassembled multilayer mechanical belt of claim 1, wherein a tip of the first angled step-joint tab and a tip of the second angled step-joint tab terminate on a same side of the multilayer mechanical belt when assembled.

10. The unassembled multilayer mechanical belt of claim 1, wherein a tip of the first angled step-joint tab and a tip of the second angled step-joint terminate on different sides of the multilayer mechanical belt when assembled.

11. The unassembled multilayer mechanical belt of claim 1, wherein the first angled step-joint tab comprises a tab length of at least about 30 mm.

12. The unassembled multilayer mechanical belt of claim 1, wherein the first angled step-joint tab comprises a tab length of not greater than about 1000 meters.

13. The unassembled multilayer mechanical belt of claim 1, wherein the second angled step-joint tab comprises a tab length of at least about 30 mm.

14. The unassembled multilayer mechanical belt of claim 1, wherein the second angled step-joint tab comprises a tab length of not greater than about 1000 meters.

15. A multilayer mechanical belt comprising spliced joint region and a central overlap region,
wherein the central overlap region comprises a first mechanical belt material layer overlying and adhered to a second mechanical belt material layer,
wherein the spliced joint region comprises a first angled step-joint tab extending from the first mechanical belt material layer and a second angled-step-joint tab extending from the second mechanical belt material layer,
wherein the first angled step-joint tab comprises a first tab backing material and a first tab adhesive material;
wherein the second angled step-joint tab comprises a second tab backing material and a second tab adhesive material; and
wherein the first angled step-joint tab overlaps with and adheres to the second angled step-joint tab.

16. The multilayer mechanical belt of claim 15, wherein the spliced joint region comprises a breaking strength increase rating of at least about 10%, where the breaking strength increase rating is defined as the percent increase in break strength of the spliced joint region formed from the first angled step-joint tab, and the second angled step-joint tab as compared to the break strength of a spliced joint region having two non-angled step-joint tabs.

17. The multilayer mechanical belt of claim 15, wherein the spliced joint region comprises a breaking strength of at least about 360 N.

18. The multilayer mechanical belt of claim 15, wherein the spliced joint region comprises a breaking strength of not greater than about 10,000 N.

19. The multilayer mechanical belt of claim 15, wherein the first angled step-joint tab comprises a tip angle of not greater than 89°.

20. The multilayer mechanical belt of claim 15, wherein the first angled step-joint tab comprises a tip angle of at least about 1°.
